(19) United States
(12) Patent Application Publication
(10) Pub. No.: US 2017/0242800 A1
(43) Pub. Date: Aug. 24, 2017

(54) APPARATUS AND METHOD FOR HASH GENERATION

(71) Applicant: FUJITSU LIMITED, Kawasaki-shi (JP)

(72) Inventor: Tsuguchika TABARU, Machida (JP)

(73) Assignee: FUJITSU LIMITED, Kawasaki-shi (JP)

(21) Appl. No.: 15/420,634

(22) Filed: Jan. 31, 2017

(30) Foreign Application Priority Data
Feb. 19, 2016 (JP) 2016-029516

(51) Int. Cl. G06F 12/1018

(52) U.S. Cl. CPC G06F 12/1018

(57) ABSTRACT

A disclosed hash generation method includes: calculating a hash matrix for identifying original data, which corresponds to a product multiplied by a partial hash matrix of a last block of plural blocks divided from the original data, from a product for each of blocks other than the last block, which is calculated by multiplying from a partial hash matrix of a first block of the plural blocks up to a partial hash matrix of the block; and calculating a hash matrix for identifying changed data, by multiplying a product of a product multiplied lastly by a partial hash matrix of a block immediately before a changed block and a partial hash matrix of the changed block by an inverse matrix of a product multiplied lastly by a partial hash matrix of an unchanged original block and a product multiplied lastly by a partial hash matrix of the last block.

### CROSS-REFERENCE TO RELATED APPLICATIONS

This application is based upon and claims the benefit of priority of the prior Japanese Patent Application No. 2016-029516, filed on Feb. 19, 2016, the entire contents of which are incorporated herein by reference.

### FIELD

This invention relates to a technique for calculation of hash data.

### BACKGROUND

A part of original data may be changed after a hash value is generated based on the original data. In such a case, it is assumed that a hash value will be newly found based on the changed data.

Generally, a hash value is calculated based on changed data using the same procedures as in the case of the original data.

However, in the case that data is partially changed, it is preferable that an amount of computation required for recalculating hash data such as a hash value is small.

Patent Document 1: Japanese Laid-open Patent Publication No. 2010-49037

Patent Document 2: Japanese Laid-open Patent Publication No. 2010-49126

There is no technique for reducing the amount of computation required for recalculating hash data.

### SUMMARY

An information processing apparatus relating to one aspect includes: a memory and a processor coupled to the memory. And the processor is configured to: calculate a first hash matrix for identifying original data, which corresponds to a first product multiplied by a partial hash matrix that is based on a last block of plural blocks divided from the original data, from a second product for each of blocks other than the last block, the second product for each of blocks other than the last block being stored in the memory and being calculated by multiplying from a partial hash matrix that is based on a first block of the plural blocks up to a partial hash matrix that is based on the block; and calculate a second hash matrix for identifying changed data, by multiplying a third product of a fourth product multiplied lastly by a partial hash matrix that is based on a block immediately before a changed block and a partial hash matrix that is based on the changed block by an inverse matrix of a fifth product multiplied lastly by a partial hash matrix that is based on an unchanged original block and a sixth product multiplied lastly by a partial hash matrix that is based on the last block, upon detecting that a part of the original data has been changed.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a process of calculating a hash value;

FIG. 2 is a diagram depicting the process of calculating the hash value;

FIG. 3 is a diagram depicting the process of calculating the hash value;

FIG. 4 is a diagram depicting the process of calculating the hash value;

FIG. 5 is a diagram depicting first expressions and second expressions related to matrices;

FIG. 6 is a diagram depicting a process of calculating a hash value when a block is changed;

FIG. 7 is a diagram depicting the first expressions and the second expressions related to the matrices;

FIG. 8 is a diagram depicting a process of calculating a hash value when a block is changed;

FIG. 9 is a diagram depicting the first expressions and the second expressions related to the matrices;

FIG. 10 is a diagram depicting a process of calculating a hash value when a block is changed;

FIG. 11 is a diagram depicting the first expressions and the second expressions related to the matrices;

FIG. 12 is a diagram depicting a process of calculating a hash value when a block is changed;

FIG. 13 is a diagram depicting the first expressions and the second expressions related to the matrices;

FIG. 14 is a diagram depicting a process of calculating a hash value when a block is added;

FIG. 15 is a diagram depicting the first expressions and the second expressions related to the matrices;

FIG. 16 is a diagram depicting a process of modifying a first product;

FIG. 17 is a diagram depicting the first expressions and the second expressions related to the matrices;

FIG. 18 is a diagram depicting the process of modifying the first product;

FIG. 19 is a diagram depicting the first expressions and the second expressions related to the matrices;

FIG. 20 is a diagram depicting the process of modifying the first product;

FIG. 21 is a diagram depicting the first expressions and the second expressions related to the matrices;

FIG. 22 is a diagram depicting the process of modifying the first product;

FIG. 23 is a diagram depicting the first expressions and the second expressions related to the matrices;

FIG. 24 is a diagram depicting the process of modifying the first product;

FIG. 25 is a diagram depicting the first expressions and the second expressions related to the matrices;

FIG. 26 is a diagram depicting the process of modifying the first product;

FIG. 27 is a diagram depicting the first expressions and the second expressions related to the matrices;

FIG. 28 is a diagram depicting the process of modifying the first product;

FIG. 29 is a diagram depicting the first expressions and the second expressions related to the matrices;

FIG. 30 is a diagram depicting an example of module configuration of a hash generation apparatus;

FIG. 31 is a diagram depicting a main processing flow;

FIG. 32 is a diagram depicting a main processing flow;

FIG. 33 is a diagram depicting an example of module configuration of an initial calculation unit;

FIG. 34 is a processing flow of an initial processing;

FIG. 35 is a diagram depicting an example of module configuration of a change unit;

FIG. 36 is a processing flow of a change processing;

FIG. 37 is a diagram depicting an example of module configuration of an addition unit;

FIG. 38 is a processing flow of an addition processing;

FIG. 39 is a processing flow of a calculation processing;

FIG. 40 is a diagram depicting an example of module configuration of a modification unit;

FIG. 41 is a processing flow of a modification processing;

FIG. 42 is a processing flow of a modification processing; and

FIG. 43 is a functional block diagram of a computer.

### DESCRIPTION OF EMBODIMENTS

In this embodiment, part of internal data that is generated in a process of calculating a hash value for the original data is stored. Then, when the original data is changed, a new hash value is calculated with less computation using the internal data. The original data may be about 1 terabyte, for example.

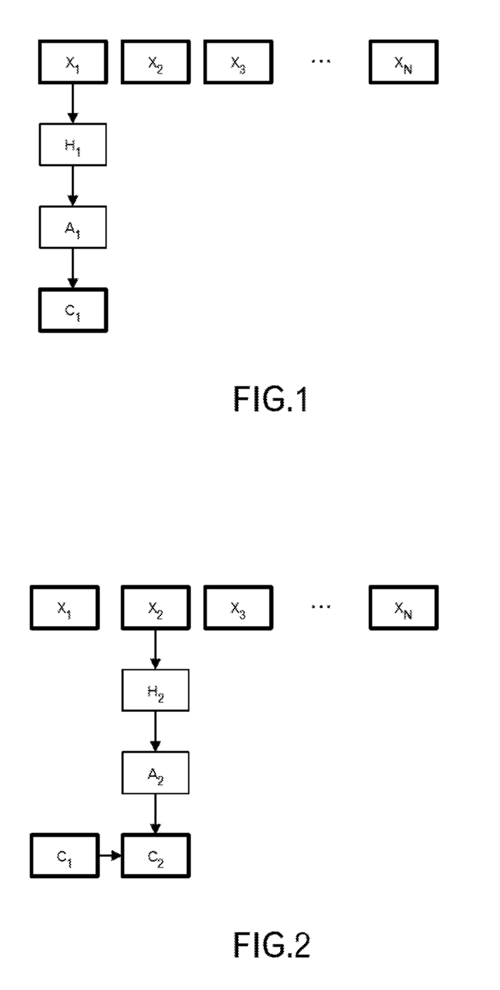

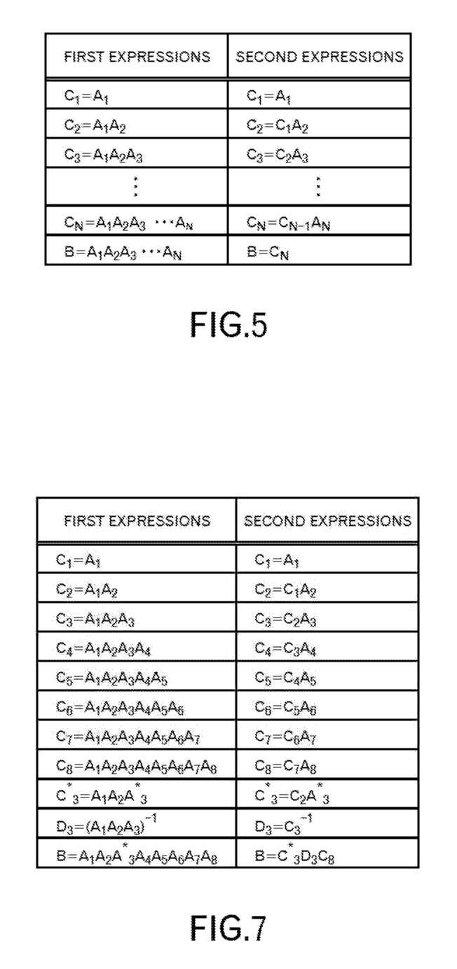

Firstly FIG. 1 to FIG. 4 illustrates a process of calculating a hash value. Furthermore, FIG. 5 illustrates expressions related to matrices that are used in that process. The first expressions in this example are expressions that define matrices that are illustrated on the left side. Similarly, the second expressions are expressions for calculating matrices that are illustrated on the left side.

First, FIG. 1 will be explained. The original data for which a hash value is generated is divided into blocks having a predetermined length (for example, 64 kibibytes). In this example, the original data is divided into N blocks. The block number i is a natural number from 1 to N. In this example, a block is written as Xᵢ. In other words, the original data is divided into block X₁, block X₂, block X₃, . . . block Xₙ.

First, the hash value H₁ is generated from block X₁. In the following, the hash value obtained from each block Xᵢ is called a first hash value. Moreover, a hash value is written as Hᵢ. Since the first hash value is based on part of the original data, the first hash value is a partial hash value. The size of the hash value in this example is 256 bits. A hash function for finding a hash value is based on a conventional technique.

The first hash value H₁ is converted to a hash matrix A₁. In the following, the hash matrix that is obtained from each of the first hash values Hᵢ is called first hash matrix. Moreover, a first hash matrix is written as Aᵢ. Since the first hash matrix Aᵢ is based on part of the original data, the first hash matrix is a partial hash matrix. In this example, the hash matrix Aᵢ is a square matrix of 4 rows*4 columns.

The hash value Hᵢ is divided into 16-bit codes. For example, a hash value is divided every 16 bits starting from the least significant bit. Then, the first to the fourth codes that are obtained by division are assigned to the element of the first column to the element of the fourth column of the first row of hash matrix Aᵢ. Similarly, the fifth to the eighth codes are assigned to the element of the first column to the element of the fourth column of the second row of hash matrix Aᵢ. Similarly, the ninth to the twelfth codes are assigned to the element of the first column to the element of the fourth column of the third row of hash matrix Aᵢ. Similarly, the thirteenth to the sixteenth codes are assigned to the element of the first column to the element of the fourth column of the fourth row of hash matrix Aᵢ.

In this embodiment, a product in which hash matrices Aᵢ are sequentially multiplied is stored as internal data. The product that is generated from the initial original data is called the first product. Moreover, a first product is written as Cᵢ. The first first product is defined by the first expression “C₁=A₁” that is illustrated in FIG. 5, and is similarly found by the second expression “C₁=A₁”. In this example, the internally stored data is represented by bold lines. In other words, the blocks Xᵢ and the first products Cᵢ are internally stored.

Next, calculation for the second block X₂ will be explained using FIG. 2. The second first hash value H₂ is calculated based on the second block X₂. The second first hash value H₂ is converted to a second first hash matrix A₂.

The second first product C₂ is defined by the first expression “C₂=A₁A₂” that is illustrated in FIG. 5, and is similarly introduced by the second expression “C₂=C₁A₂”. In other words, the second first product C₂ is found by multiplying the first first product C₁ by the second first hash matrix A₂.

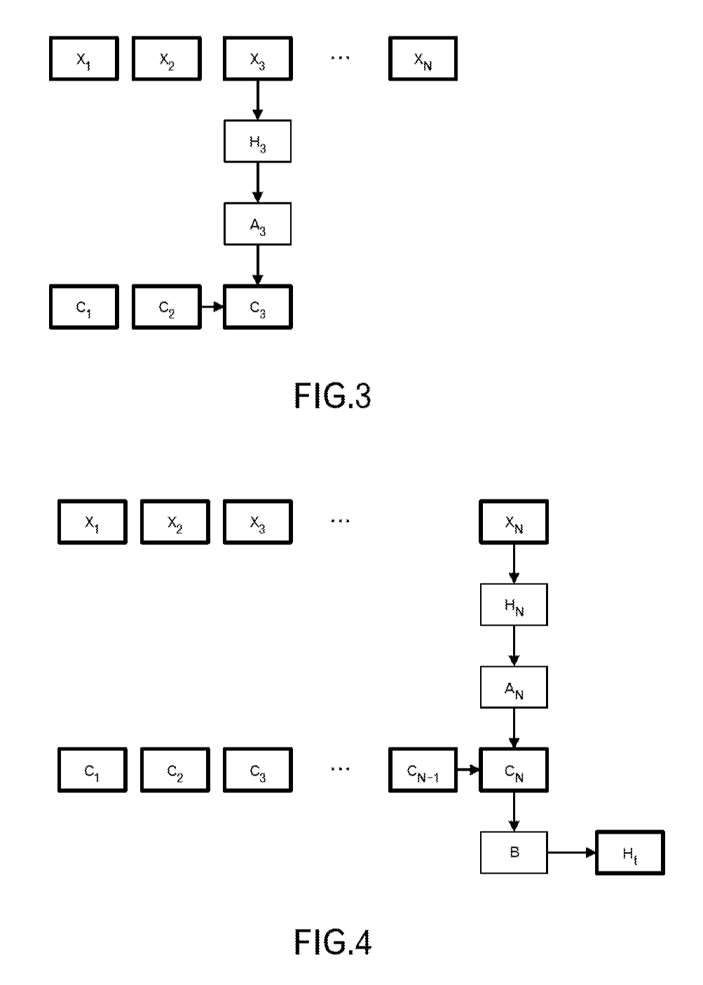

Next, calculation for the third block X₃ will be explained using FIG. 3. The third first hash value H₃ is calculated based on the third block X₃. The third first hash value H₃ is converted to a third first hash matrix A₃.

The third first product C₃ is defined by the first expression “C₃=A₁A₂A₃” that is illustrated in FIG. 5, and is similarly found by the second expression “C₃=C₂A₃”. In other words, the third first product C₃ is found by multiplying the second first product C₂ by the third first hash matrix A₃.

Similar processing is repeated up until the Nth block. FIG. 4 illustrates the processing for the Nth block. The Nth first hash value H_{N} is calculated based on the Nth block X_{N}. The Nth first hash value H_{N} is converted to an Nth first hash matrix A_{N}.

The Nth first product C_{N} is defined by the first expression “C_{N}=A₁A₂A₃ . . . A_{N}” that is illustrated in FIG. 5, and is similarly found by the second expression “C_{N}=C_{N-1}A_{N}”.

In other words, the Nth first product C_{N} is found by multiplying the (N−1) th first product C_{N-1} by the Nth first hash matrix A_{N}.

A second hash matrix B for specifying the original data is defined by the first expression “B=A₁A₂A₃ . . . A_{N}” that is illustrated in FIG. 5, and is similarly found by the second expression “B=C_{N}”. In other words, the first product C_{N} becomes the second hash matrix B for specifying the original data.

Furthermore, the second hash matrix B is converted to a second hash value Hₜ for specifying the original data. In this example, the element in the first column to the element in the fourth column of the first line of the second hash matrix B are first to fourth codes. The element in the first column to the element in the fourth column of the second line of the second hash matrix B are fifth to eighth codes. The element in the first column to the element in the fourth column of the third line of the second hash matrix B are ninth to twelfth codes. The element in the first column to the element in the fourth column of the fourth line of the second hash matrix B are thirteenth to sixteenth codes. The second hash value Hₜ is generated by combining the first to the sixteenth codes. The size of the second hash value Hₜ in this example is 256 bits.

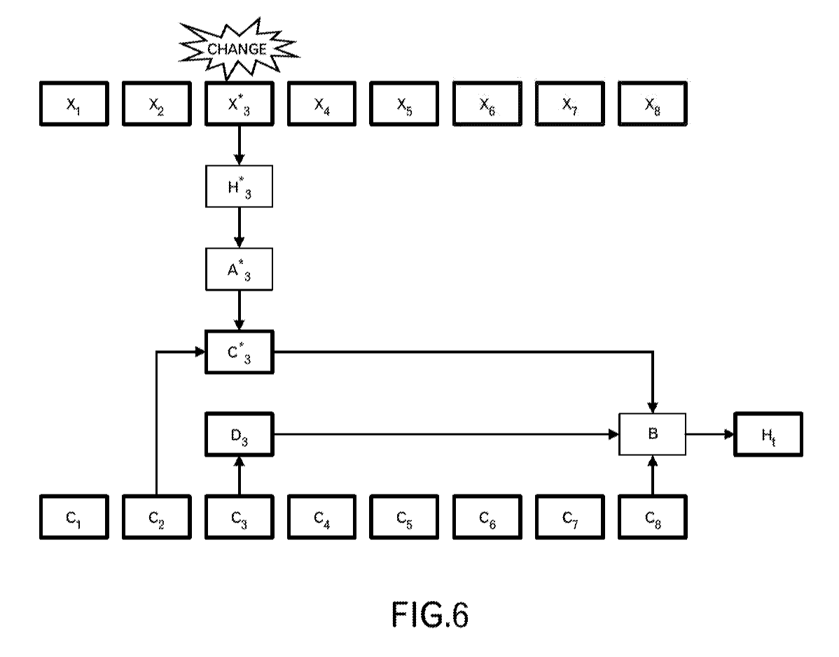

In the following, the case in which part of the blocks is changed will be explained. FIG. 6 illustrates a process of calculating a hash value when the third block is changed. The changed third block is written as X*₃. In this example, “*” is attached to a changed block. The first expressions and second expressions for the matrices related to this process of calculation are illustrated in FIG. 7.

The third new first hash value H*₃ is calculated from the third changed block X*₃. In this example, an asterisk * is attached to a changed first hash value.

Furthermore, the third new first hash value H*₃ is converted to a new first hash matrix A*₃. In this example, an asterisk * is attached to a changed first hash matrix.

Then, a second product C*₃ up to the new first hash value H*₃ is calculated. The second product C*₃ that corresponds to the third changed block X*₃ is defined by the first expression “C*₃=A₁A₂A*₃” that is illustrated in FIG. 7. In this way, a product that includes a changed first hash matrix is called a second product. Moreover, a second product is written as C*ᵢ. A second product C*ᵢ is stored internally unless it becomes unnecessary.

The second product C*₃ is found by the second expression “C*₃=C₂A*₃” that is illustrated in FIG. 7.

In other words, the third second product C*₃ is found by multiplying the second first product C₂ by the third new first hash matrix A*₃.

In this embodiment, an inverse matrix Dᵢ of a first product Cᵢ that corresponds to a changed block X*ⱼ is found. In this example, the inverse matrix D₃ that corresponds to the third changed block X*₃ is defined by the first expression “D₃=(A₁A₂A₃)⁻¹” that is illustrated in FIG. 7, and similarly is found by the second expression “D₃=C₃⁻¹” An inverse matrix Dᵢ is stored internally except unless it becomes unnecessary.

Processing to find the second hash value Hₜ in this state will be explained. The second hash matrix B in this state is defined by the first expression “B=A₁A₂A*₃A₄A₅A₆A₇A₈” that is illustrated in FIG. 7, and similarly is found by the second expression “B=C*₃D₃C₈”.

In other words, the second hash matrix B in this state is found by multiplying the third second product C*₃ by the third inverse matrix D₃, and then multiplying by the eighth first product C₈ that corresponds to the last block. The second hash matrix B is then converted to the second hash value Hₜ.

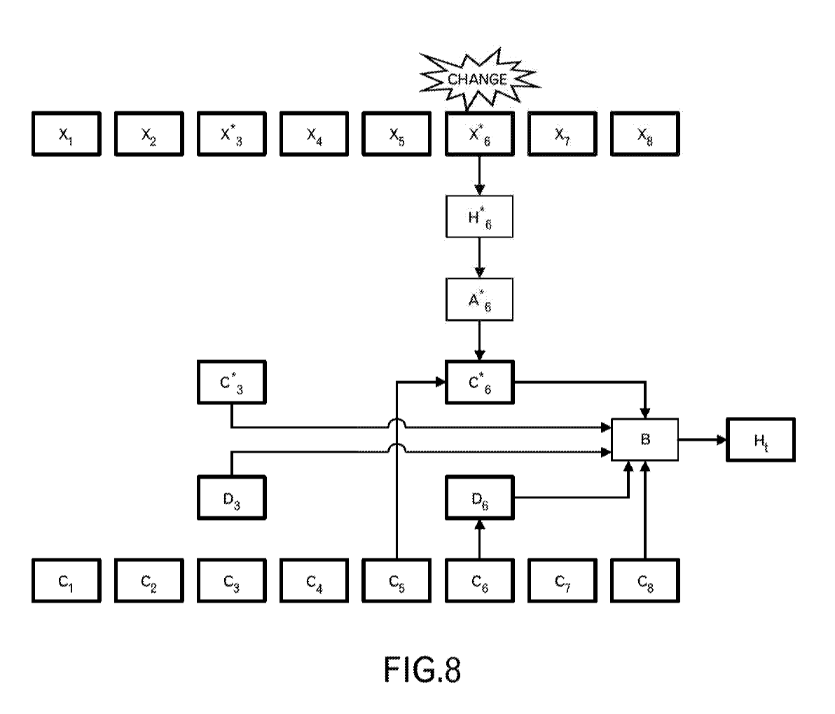

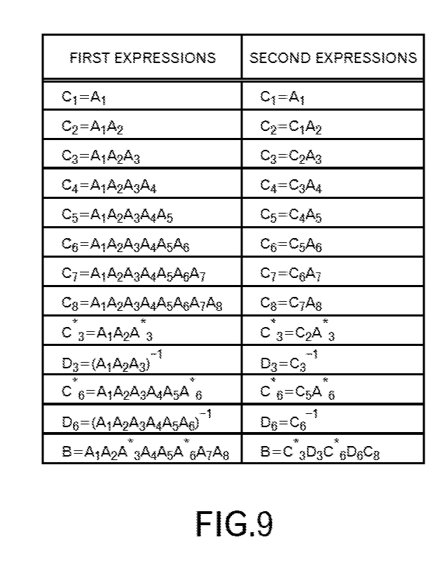

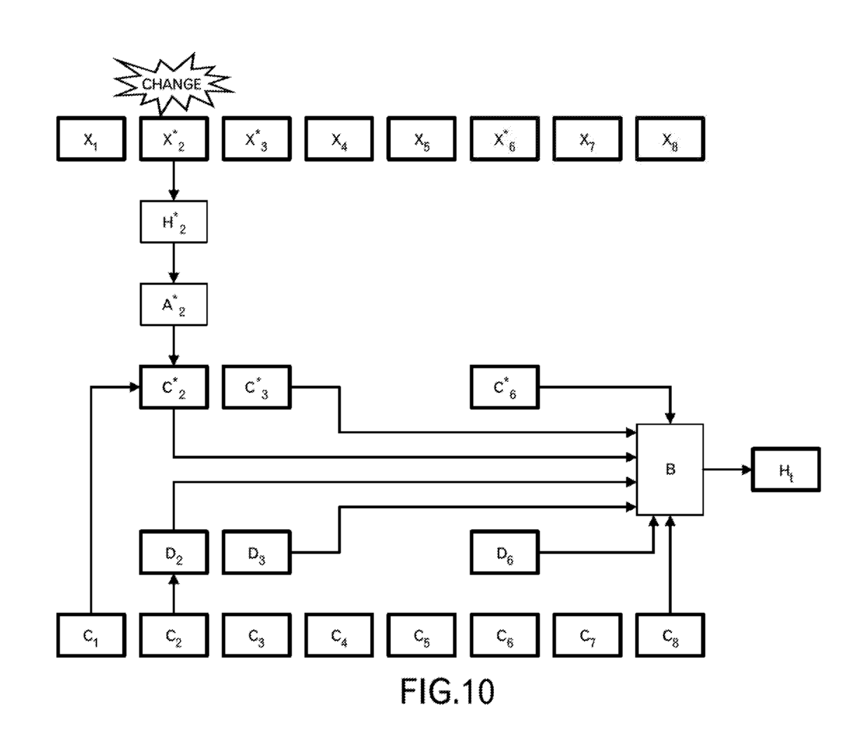

A process of calculating a hash value when the sixth block X₆ is further changed will be explained using FIG. 8. The first expressions and second expressions related to this process of calculation are illustrated in FIG. 9.

A sixth new first hash value H*₆ is calculated from the sixth changed block X*₆. The sixth new first hash value H*₆ is further converted to a new first hash matrix A*₆.

The second product C*₆ up to the new first hash value H*₆ is then calculated. The second product C*₆ that corresponds to the sixth changed block X*₆ is defined by the first expression “C*₆=A₁A₂A₃A₄A₅A*₆” that is illustrated in FIG. 9, and similarly is found by the second expression “C*₆=C₅A*₆”.

In other words, the sixth second product C*₆ is found by multiplying the fifth first product C₅ by the new first hash matrix A*₆.

Moreover, an inverse matrix D₆ that corresponds to the sixth changed block X*₆ is defined by the first expression “D₆=(A₁A₂A₃A₄A₅A₆)⁻¹” that is illustrated in FIG. 9, and similarly is found by the second expression “D₆=C₆⁻¹”.

Processing for finding the second hash value Hₜ in this state will be explained. The second hash matrix B in this state is defined by the first expression “B=A₁A₂A*₃A₄A₅A*₆A₇A₈” that is illustrated in FIG. 9, and similarly is found by the second expression “B=C*₃D₃C*₆D₆C₈”.

In other words, the second hash matrix B in this state is found by multiplying the third second product C*₃ by the third inverse matrix D₃, the sixth second product C*₆, the sixth inverse matrix D₆, and the eighth first product C₈ that corresponds to the last block. Then, the second hash matrix B is converted to the second hash value Hₜ.

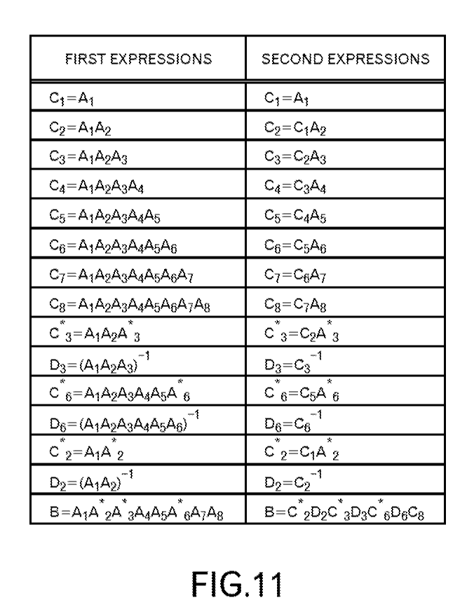

Process of calculating a hash value when the second block X₂ is changed will be explained. The first expressions and the second expressions that are related to this process of calculating are illustrated in FIG. 11.

A second new first hash value H*₂ is calculated from the second changed block X*₂ Then, the second new first hash value H*₂ is further converted to a new first hash matrix A*₂.

A second product C*₂ is then calculated up to the new first hash value H*₂ The second product C*₂ that corresponds to the second changed block X*₂ is defined by the first expression “C*₂=A₁A*₂” that is illustrated in FIG. 11, and is similarly found by the second expression “C*₂=C₁A*₂”. In other words, the second second product C*₂ is found by multiplying the first first product C₁ by the second new first hash matrix A*₂.

Moreover, an inverse matrix D₂ that corresponds to the second changed block X*₂ is defined by the first expression “D₂=(A₁A₂)⁻¹” that is illustrated in FIG. 11, and similarly is found by the second expression “D₂=C₂⁻¹”.

Processing for finding the second hash value Hₜ in this state will be explained. The second hash matrix B in this state is defined by the first expression “B=A₁A*₂A*₃A₄A₅A*₆A₇A₈” that is illustrated in FIG. 11, and is similarly found by the second expression “B=C*₂D₂C*₃D₃C*₆D₆C₈”.

In other words, the second hash matrix B in this state is found by multiplying the second second product C*₂ by the second inverse matrix D₂, the third second product C*₃, the third inverse matrix D₃, the sixth second product C*₆, the sixth inverse matrix D₆, and the eighth first product C₈ that corresponds to the last block. The second hash matrix B is then converted to the second hash value Hₜ.

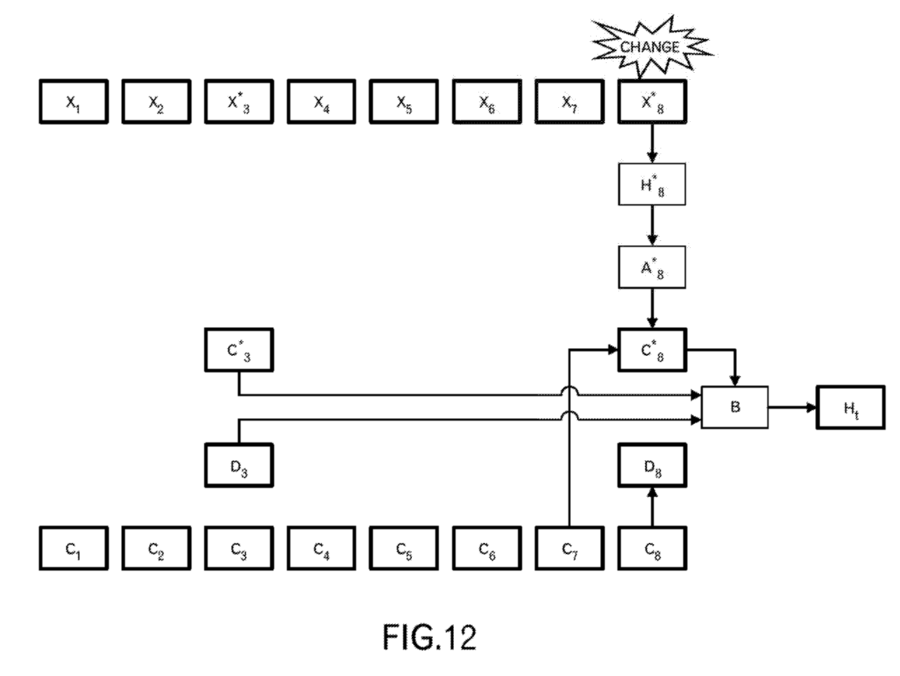

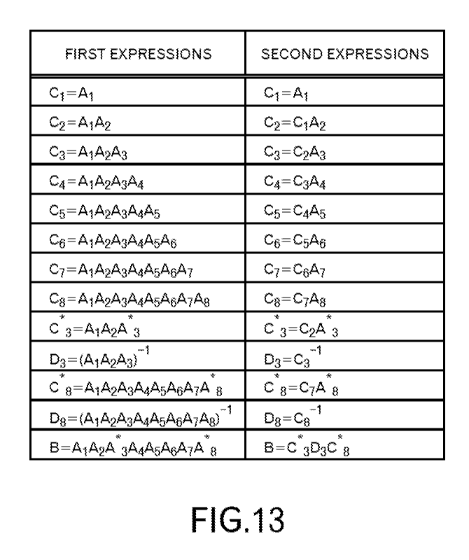

Next, a process of calculating a hash value when the last block is changed will be explained using FIG. 12. The first expressions and second expressions that are related to this process of calculating are illustrated in FIG. 13.

An eighth new first hash value H*₈ is calculated from an eighth changed block X*₈. Furthermore, the eighth new first hash value H*₈ is converted to a new first hash matrix A*₈.

A second product C*₈ is calculated up to the new first hash value H*₈ The second product C*₈ that corresponds to the eighth changed block X*₈ is defined by the expression “C*₈=A₁A₂A₃A₄A₅A₆A₇A*₈” that is illustrated in FIG. 13, and similarly is found by the second expression “C*₈=C₇A*₈”.

In other words, the eighth second product C*₈ is found by multiplying the seventh first product C₇ by the eighth new first hash matrix A*₈.

Moreover, an inverse matrix D₈ that corresponds to the eighth changed block X*₈ is defined by the first expression “D₈=(A₁A₂A₃A₄A₅A₆A₇A₈)⁻¹” that is illustrated in FIG. 13, and similarly is found by the second expression “D₈=C₈⁻¹”.

Processing for finding the second hash value Hₜ in this state will be explained. A second hash matrix B in this state is defined by the first expression “B=A₁A₂A*₃A₄A₅A₆A₇A*₈” that is illustrated in FIG. 13, and similarly is found by the second expression “B=C*₃D₃C*₈”.

In other words, a second hash matrix B in this state is found by multiplying the third second product C*₃ by a third inverse matrix D₃ and the eighth second product C*₈ that corresponds to the changed block X*₈. Here, the inverse matrix D₈ is not used. However, the inverse matrix D₈ may be used in the case of calculating the second hash matrix B later.

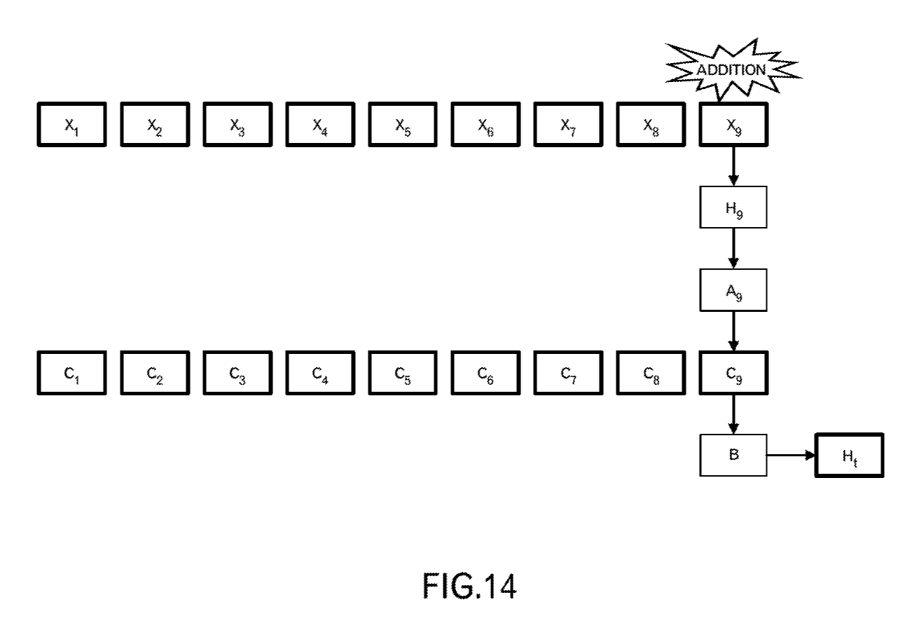

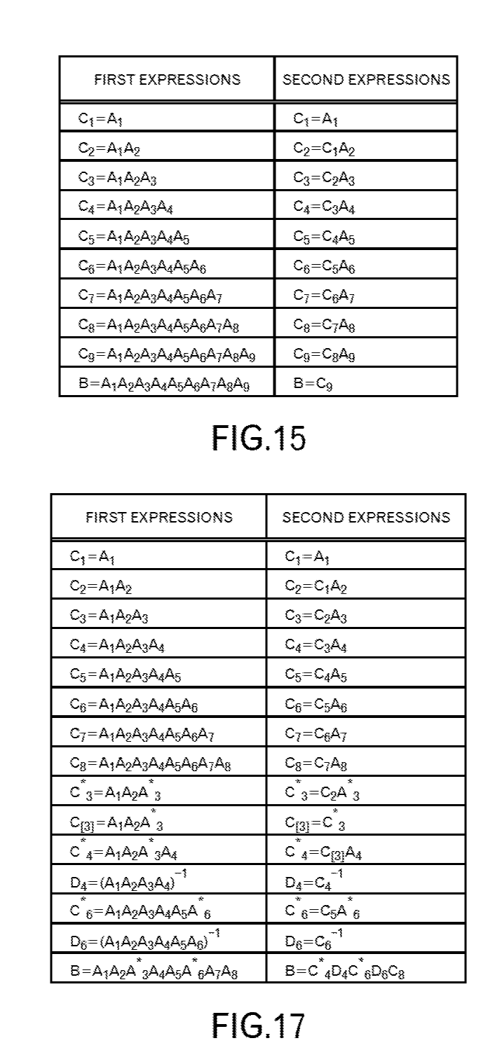

Next, a process of calculating a hash value in the case in which a block is added after the last block will be explained using FIG. 14. The first expressions and second expressions that are related to this process of calculating are illustrated in FIG. 15.

A first hash value H₉ is calculated from the added ninth block X₉. Furthermore, the first hash value H₉ is converted to a first hash matrix A₉.

A first product C₉ is then calculated up to the first hash value H₉. The first product C₉ that corresponds to the ninth block X₉ is defined by the first expression “C₉=A₁A₂A₃A₄A₅A₆A₇A₈A₉” that is illustrated in FIG. 15, and is similarly found by the second expression “C₉=C₈A₉”. In other words, the ninth first product C₉ is found by multiplying the eighth first product C₈ by the first hash matrix A₉.

Processing for finding the second hash value Hₜ in this state will be explained. A second hash matrix B in this state is defined by the first expression “B=A₁A₂A₃A₄A₅A₆A₇A₈A₉” that is illustrated in FIG. 15, and similarly is found by the second expression “B=C₉”. In other words, the first product C₉ becomes the second hash matrix B. The second hash matrix B is then converted to the second hash value Hₜ.

As described above, as the number of changed blocks X*ᵢ increases, the number of terms of an expression for calculating the second hash matrix B increases. Therefore, the amount of computation for calculating the second hash matrix B increases. Moreover, the number of second products C*ᵢ and inverse matrices Dᵢ that are stored internally also increases. As a result, the amount of storage increases. In order to eliminate these problems, in this embodiment, the number of second products C*ᵢ and inverse matrices Dᵢ are reduced and the amount of computation is also reduced by modifying the first products Cᵢ.

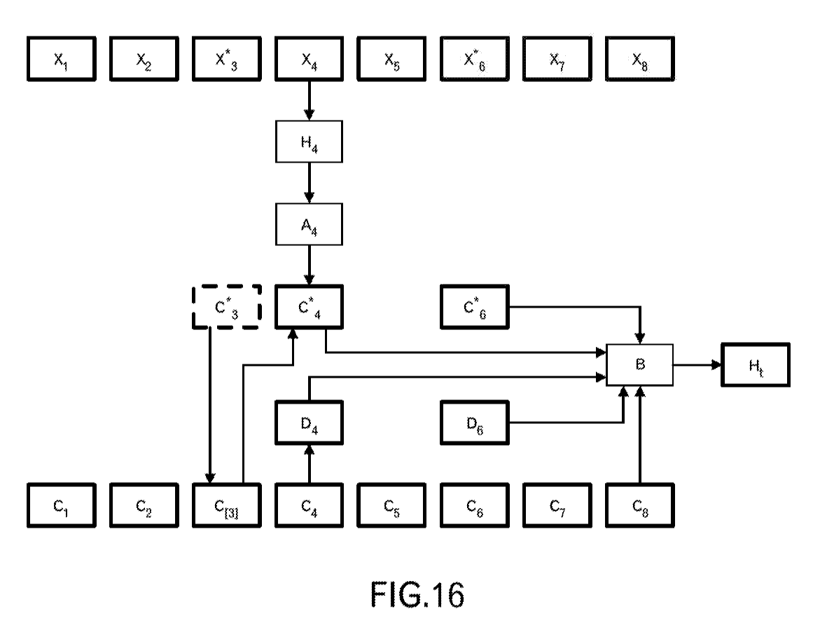

FIG. 16 illustrates a process of modifying the third first product C₃ in a state in which the third and sixth blocks have been changed. The first expressions and second expressions for matrices related to this process of modifying are illustrated in FIG. 17.

First, the first block of the blocks that have already been changed is specified. In this example, changed block X*₃ is specified.

Then, the second product C*₃ that corresponds to the changed block X*₃ is copied to the first product C_{[3]} that corresponds to the changed block X*₃. In this example, brackets are attached to a number of an updated first product.

Next, the second product C*₄ that corresponds to the next block X₄ after the changed block X*₃ is calculated based on the updated first product C_{[3]}.

Therefore, a first hash value H₄ is calculated from the fourth block X₄ Furthermore, the first hash value H₄ is converted to a first hash matrix A₄.

A second product C*₄ that corresponds to the block X₄ is calculated. In this example, an asterisk * is attached to the updated second product. The second product C*₄ is defined by the first expression “C*₄=A₁A₂A*₃A₄” that is illustrated in FIG. 17, and is similarly found by the second expression “C*₄=C_{[3]}A₄”. In other words, the second product C*₄ is found by multiplying the third updated first product C_{[3]} by the first hash matrix A₄.

Furthermore, an inverse matrix D₄ that corresponds to the block X₄ is generated. The inverse matrix D₄ is defined by the first expression “D₄=(A₁A₂A₃A₄)⁻¹” that is illustrated in FIG. 17, and is similarly found by the second expression “D₄=C₄⁻¹”.

The second product C*₃ and inverse matrix D₃ that correspond to the changed block X*₃ are then deleted.

The process for finding a second hash value Hₜ in this state will be explained. A second hash matrix B in this state is defined by the first expression “B=A₁A₂A*₃A₄A₅A*₆A₇A₈” that is illustrated in FIG. 17, and similarly is found by the second expression “B=C*₄D₄C*₆D₆C₈”.

In other words, the second hash matrix B in this state is found by multiplying the fourth second product C*₄ by the fourth inverse matrix D₄, the sixth second product C*₆, the sixth inverse matrix D₆, and the eighth first product C₈ that corresponds to the last block. The second hash matrix B is then converted to a second hash value Hₜ.

After that, the changed block X*₃ is regarded as equivalent to an unchanged block, and the next block X₄ is regarded as equivalent to a changed block. The number of changed blocks or blocks that are regarded as changed blocks are registered in an update list that will be described later. Then, the first block of the changed blocks or blocks that are regarded as changed blocks is specified and the processing for modifying the first products Cᵢ is repeated.

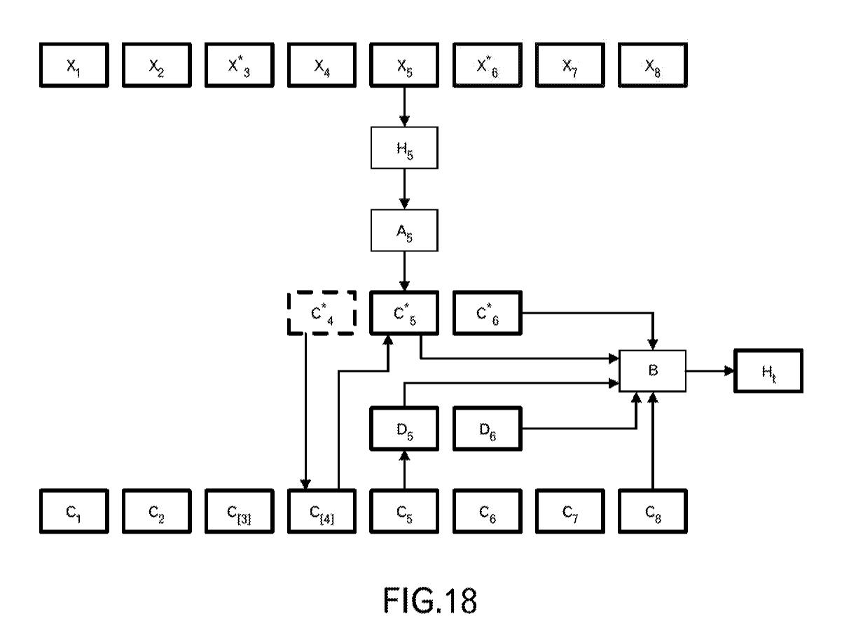

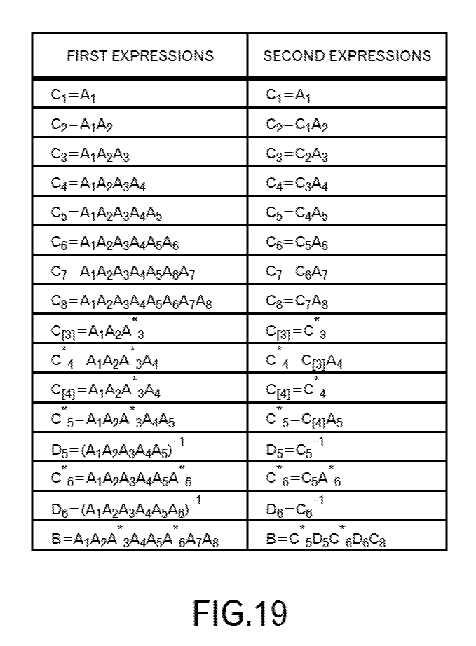

FIG. 18 illustrates processing for modifying the fourth first product C₄ after the state illustrated in FIG. 16. The first expressions and second expressions of matrices that are related to this process of modifying are illustrated in FIG. 19.

First, the block X₄ that is regarded as the changed block is specified. Then, the second product C*₄ that corresponds to the block X₄ is copied to the first product C_{[4]}.

Next, a second product C*₅ that corresponds to the next block X₅ is calculated based on the updated first product C_{[4]}. Therefore, the first hash value H₅ is calculated from the fifth block X₅. Furthermore, the first hash value H₅ is converted to the first hash matrix A₅.

Then, a second product C*₅ that corresponds to the block X₅ is calculated. The second product C*₅ is defined by the first expression “C*₅=A₁A₂A*₃A₄A₅” that is illustrated in FIG. 19, and is similarly found by the second expression “C*₅=C_{[4]}A₅”. In other words, the second product C*₅ is found by multiplying the fourth updated first product C_{[4]} by the first hash matrix A₅.

Furthermore, an inverse matrix D₅ that corresponds to the block X₅ is generated. The inverse matrix D₅ is defined by the first expression “D₅=(A₁A₂A₃A₄A₅)⁻¹” that is illustrated in FIG. 19, and similarly is found by the second expression “D₅=C₅⁻¹”.

The second product C*₄ and the inverse matrix D₄ that correspond to the block X₄ are then deleted. An explanation of the process for finding a second hash value Hₜ in this state is omitted.

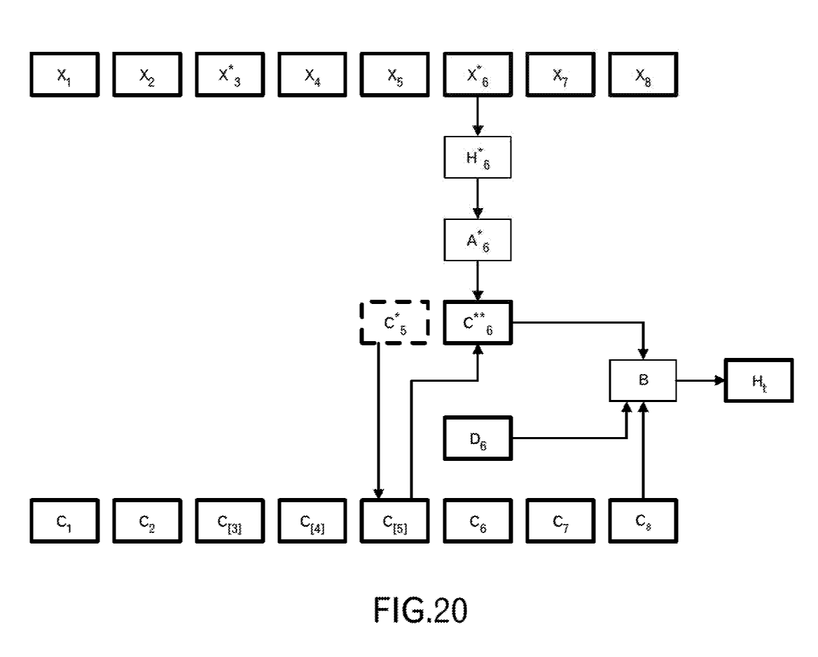

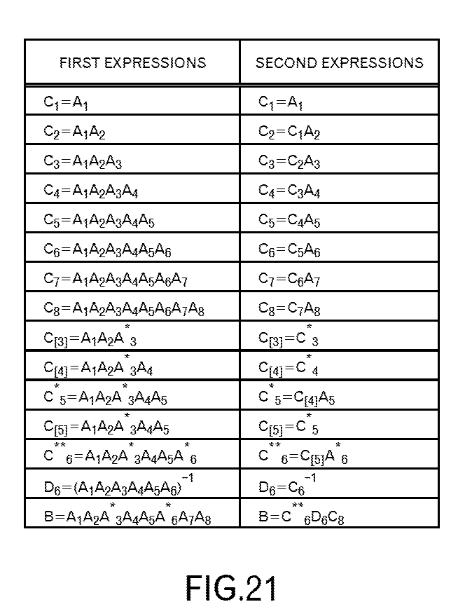

FIG. 20 illustrates a process of modifying the fifth first product C₅ after the state illustrated in FIG. 18. The first expressions and the second expressions for the matrices that are related to this process of modifying are illustrated in FIG. 21.

First, block X₅ that is regarded as the changed block is specified. Then, a second product C*₅ that corresponds to block X₅ is copied to the first product C_{[5]}.

Next, a second product C*₆ that corresponds to the next changed block X*₆ is modified based on the updated first product C_{[5]}. Therefore, a first hash value H*₆ is calculated from the sixth block X*₆. Furthermore, the first hash value H*₆ is converted to a first hash matrix P′₆.

A second product C**₆ that corresponds to the block X*₆ is then calculated. In this example, an asterisk * is further attached to updated second products. The second product C**₆ is defined by the first expression “C**₆=A₁A₂A*₃A₄A₅A*₆” that is illustrated in FIG. 21, and similarly is found by the second expression “C**₆=C_{[5]}A*₆”. In other words, the second product C**₆ is found by multiplying the fifth updated first product C_{[5]} by the first hash matrix A*₆.

Furthermore, an inverse matrix D₆ that corresponds to the block X*₆ is generated. The inverse matrix D₆ is defined by the first expression “D₆=(A₁A₂A₃A₄A₅A₆)⁻¹” that is illustrated in FIG. 21, and is similarly found by the second expression “D₆=C₆⁻¹”.

The second product C*₅ and inverse matrix D₅ that correspond to the block X₅ are then deleted. An explanation of processing for finding a second hash value Hₜ in this state is omitted.

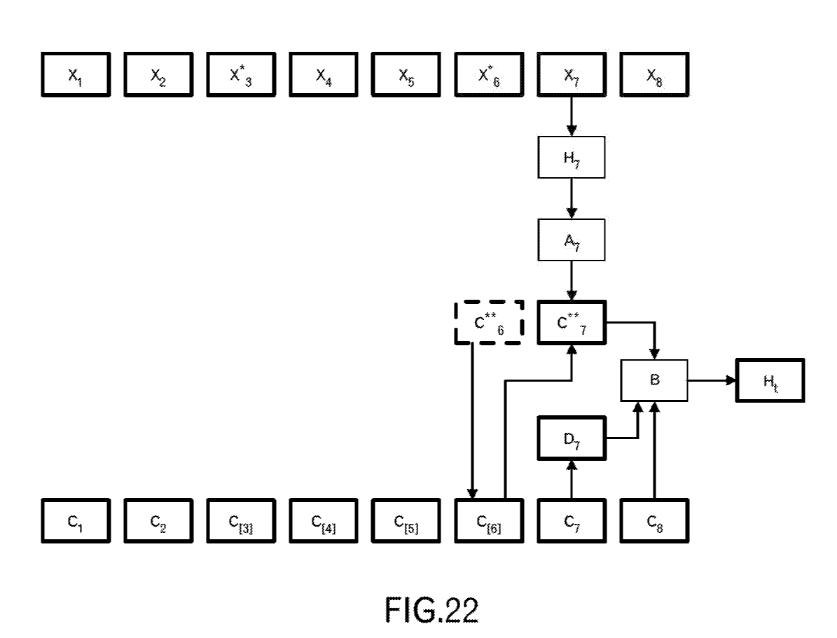

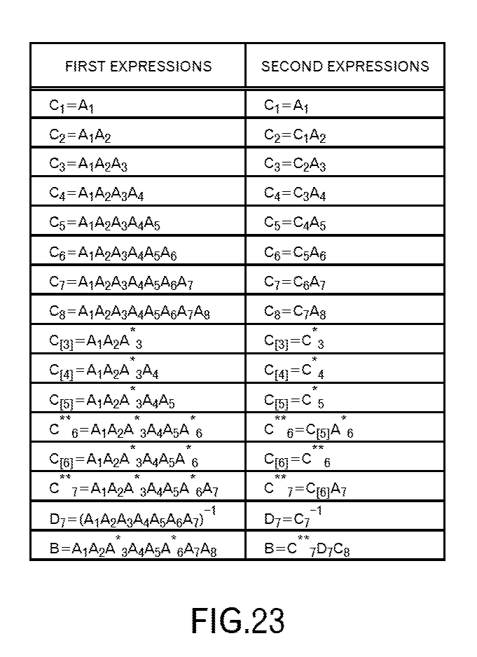

FIG. 22 illustrates a process of modifying the sixth first product C₆ after the state illustrated in FIG. 20. The first expressions and the second expressions that are related to this process of modifying are illustrated in FIG. 23.

First, the changed block X*₆ is specified. Then, the second product C**₆ that corresponds to the changed block X*₆ is copied to the first product C_{[6]}.

Next, a second product C**₇ that corresponds to the next block X₇ is generated based on the updated first product C_{[6]}. Therefore, a first hash value H₇ is calculated from the seventh block X₇. Furthermore, the first hash value H₇ is converted to a first hash matrix A₇.

A second product C**₇ that corresponds to the block X₇ is then calculated. In this example, as well as the second product C**₆, two asterisks * are attached. The second product C**₇ is defined by the first expression “C**₇=A₁A₂A*₃A₄A₅A*₆A₇” that is illustrated in FIG. 23, and is similarly found by the second expression “C**₇=C_{[6]}A₇”. In other words, the second product C**₇ is found by multiplying the sixth updated first product C_{[6]} by the first hash matrix A₇.

Furthermore, an inverse matrix D₇ that corresponds to the block X₇ is generated. The inverse matrix D₇ is defined by the first expression “D₇=(A₁A₂A₃A₄A₅A₆A₇)⁻¹” that is illustrated in FIG. 23, and is similarly found by the second expression “D₇=C₇⁻¹”.

The second product C**₆ and inverse matrix D₆ that correspond to the block X*₆ are then deleted. An explanation of the process for finding a second hash value Hₜ in this state is omitted.

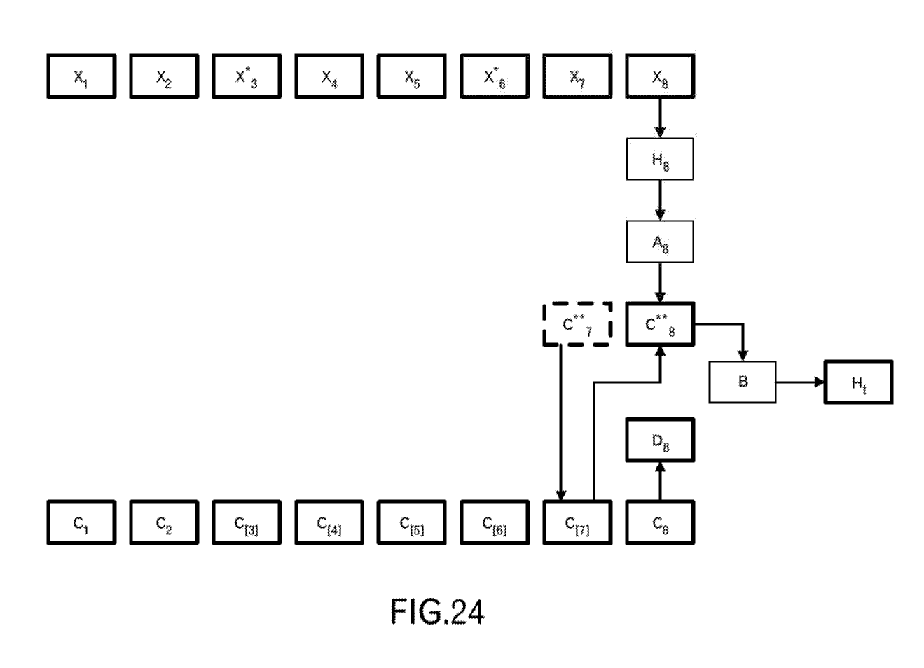

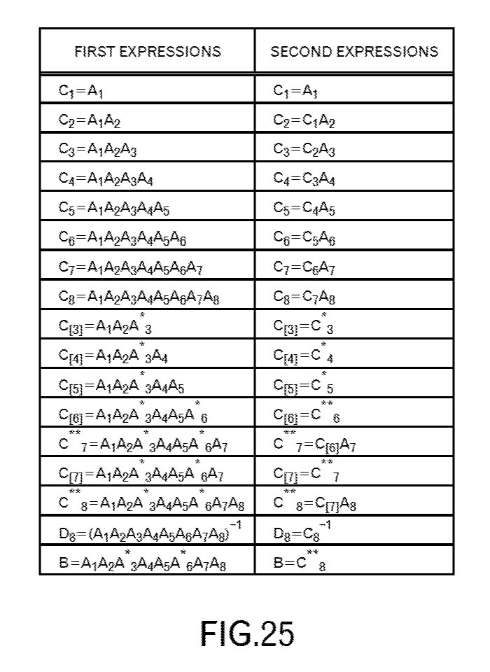

FIG. 24 illustrates a process of modifying the seventh first product C₇ after the state illustrated in FIG. 22. The first expressions and the second expressions of the matrices that are related to this process of modifying are illustrated in FIG. 25.

First, the block X₇ that is regarded as the changed block is specified. Then, a second product C**₇ that corresponds to the block X₇ is copied to the first product C_{[7]}.

Next, a second product C**₈ that corresponds to the next block X₈ is generated based on the updated first product C_{[7]}. Therefore, a first hash value H₈ is calculated from the eighth block X₈. Furthermore, the first hash value H₈ is converted to a first hash matrix A₈.

A second product C**₈ that corresponds to the block X₈ is then calculated. The second product C**₈ is defined by the first expression “C**₈=A₁A₂A*₃A₄A₅A*₆A₇A₈” that is illustrated in FIG. 25, and is similarly found by the second expression “C**₈=C_{[7]}A₈”. In other words, the second product C**₈ is found by multiplying the seventh updated first product C_{[7]} by the first hash matrix A₈.

Furthermore, an inverse matrix D₈ that corresponds to the block X₈ is generated. The inverse matrix D₈ is defined by the first expression “D₈=(A₁A₂A₃A₄A₅A₆A₇A₈)⁻¹” that is illustrated in FIG. 25, and similarly is found by the second expression “D₈=C₈⁻¹”.

The second product C**₇ and inverse matrix D₇ that correspond to the block X₇ are then deleted. An explanation of the process for finding a second hash value Hₜ in this state is omitted.

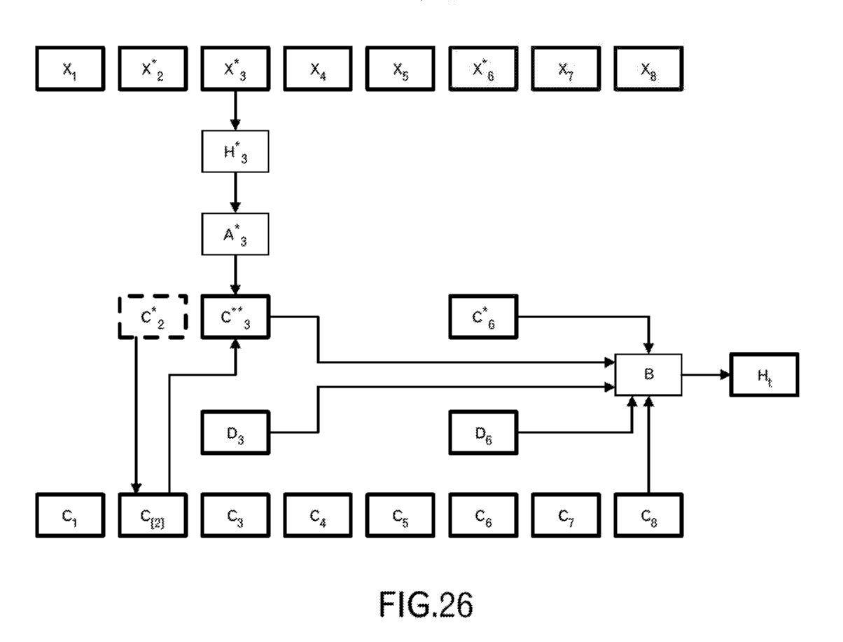

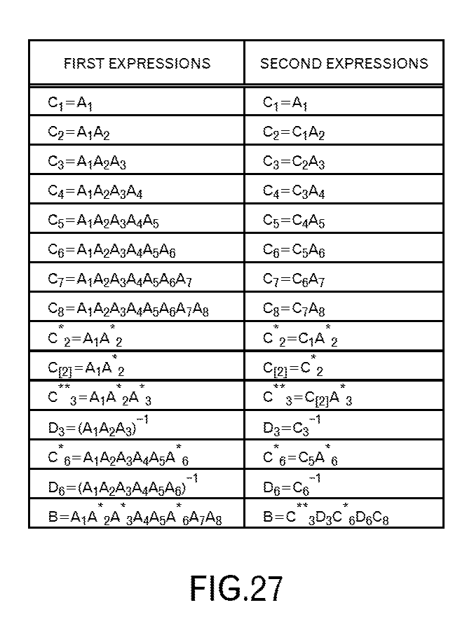

Next, a case where a first product is modified in a state where change blocks are in succession will be explained. FIG. 26 illustrates a process of modifying the second first product C₂ in a state in which the second, third and sixth blocks have been changed. The first expressions and the second expressions of the matrices that are related to this process of modifying are illustrated in FIG. 27.

First, the first block of the blocks that have already been changed is specified. In this example, the changed block X*₂ is specified.

Then, the second product C*₂ that corresponds to the changed block X*₂ is copied to the first product C_{[2]} that corresponds to the changed block X*₂. In this example, brackets are attached to a number of an updated first product.

Next, the second product C*₃ that corresponds to the next changed block X*₃ after the changed block X*₂ is modified based on the updated first product C_{[2]}.

Therefore, a first hash value H*₃ is calculated from the third changed block X*₃. Furthermore, the first hash value H*₃ is converted to a first hash matrix A*₃.

A second product C**₃ that corresponds to the changed block X*₃ is then calculated. The second product C**₃ is defined by the first expression “C**₃=A₁A*₂A*₃” that is illustrated in FIG. 27, and is similarly found by the second expression “C**₃=C_{[2]}A*₃”. In other words, the second product C**₃ is found by multiplying the second updated first product C_{[2]} by the first hash matrix A*₃.

Furthermore, an inverse matrix D₃ that corresponds to the block X*₃ is generated. The inverse matrix D₃ is defined by the first expression “D₃=(A₁A₂A₃)⁻¹” that is illustrated in FIG. 27, and is similarly found by the second expression “D₃=C₃⁻¹”.

The second product C*₂ and the inverse matrix D₂ that correspond to the changed block X*₂ are then deleted. An explanation of the process for finding a second hash value Hₜ in this state is omitted.

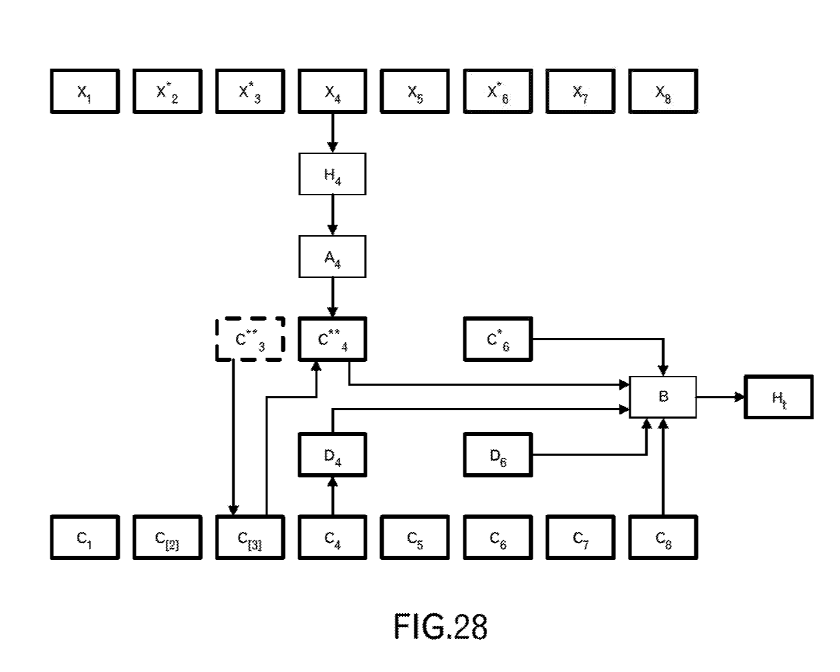

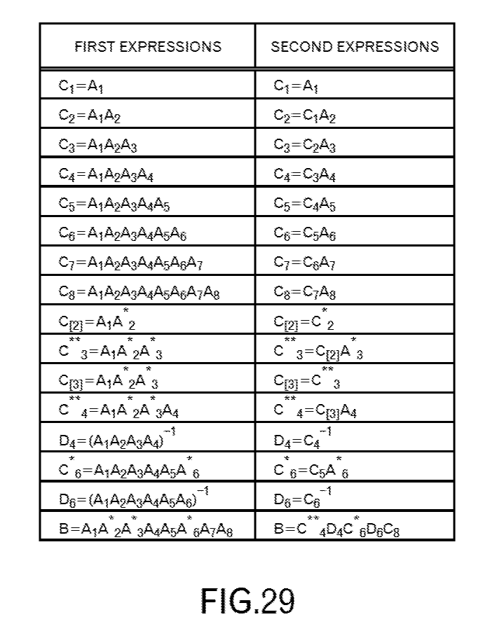

FIG. 28 illustrates a process of modifying the third first product C₃ after the state illustrated in FIG. 26. FIG. 29 illustrates the first expressions and the second expressions for matrices related to this process of modifying.

First, the changed block X*₃ is specified. The second product C**₃ that corresponds to the changed block X*₃ is copied to the first product C_{[3]}.

Next, a second product C**₄ that corresponds to the next block X₄ is generated based on the updated first product C_{[3]}. Therefore, a first hash value H₄ is calculated from the fourth block X₄. Furthermore, the first hash value H₄ is converted to a first hash matrix A₄.

A second product C**₄ that corresponds to the block X₄ is then calculated. The second product C**₄ is defined by the first expression “C**₄=A₁A*₂A*₃A₄” that is illustrated in FIG. 29, and is similarly found by the second expression “C**₄=C_{[3]}A₄”. In other words, the second product C**₄ is found by multiplying the third updated first product C_{[3]} by the first hash matrix A₄.

Furthermore, an inverse matrix D₄ that corresponds to the block X₄ is generated. The inverse matrix D₄ is defined by the first expression “D₄=(A₁A₂A₃A₄)⁻¹” that is illustrated in FIG. 29, and is similarly found by the second expression “D₄=C₄⁻¹”.

The second product C**₃ and the inverse matrix D₃ that correspond to the block X*₃ are then deleted. An explanation of processing for finding a second hash value Hₜ in this state is omitted. This completes an explanation of an outline of processing related to this embodiment.

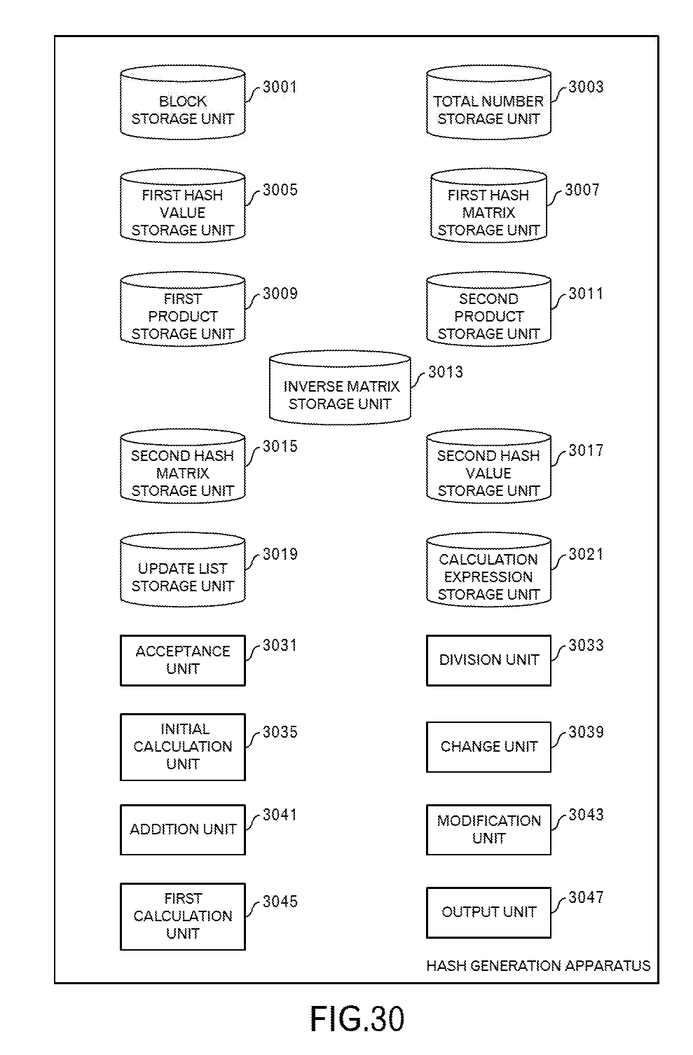

FIG. 30 illustrates an example of module configuration of a hash generation apparatus. The hash generation apparatus has a block storage unit 3001, a total number storage unit 3003, a first hash value storage unit 3005, a first hash matrix storage unit 3007, a first product storage unit 3009, a second product storage unit 3011, an inverse matrix storage unit 3013, a second hash matrix storage unit 3015, a second hash value storage unit 3017, an update list storage unit 3019, and a calculation expression storage unit 3021.

In the following, variable symbols are omitted. The block storage unit 3001 stores each of the blocks. The total number storage unit 3003 stores the number of blocks. The first hash value storage unit 3005 stores first hash values based on each of the blocks. The first hash matrix storage unit 3007 stores first hash matrices based on the first hash values. The first product storage unit 3009 stores first products that correspond to each of the blocks. The second product storage unit 3011 stores second products that correspond to changed blocks. The inverse matrix storage unit 3013 stores inverse matrices of the first products that correspond to the changed blocks. The second hash matrix storage unit 3015 stores a second hash matrix. The second hash value storage unit 3017 stores a second hash value. The update list storage unit 3019 stores an update list in which numbers of changed blocks and numbers of blocks that are regarded as changed blocks are set. Hereinafter, changed blocks and blocks that are regarded as changed blocks will be referred to as updated blocks, and the numbers of changed blocks and the numbers of blocks that are regarded as changed blocks will be called numbers of updated blocks. The calculation expression storage unit 3021 stores matrices that correspond to terms that are included in a calculation expression in order of multiplication.

The block storage unit 3001, the total number storage unit 3003, the first hash value storage unit 3005, the first hash matrix storage unit 3007, the first product storage unit 3009, the second product storage unit 3011, the inverse matrix storage unit 3013, the second hash matrix storage unit 3015, the second hash value storage unit 3017, the update list storage unit 3019 and the calculation expression storage unit 3021 are realized using hardware resources (for example, refer to FIG. 43).

The hash generation apparatus further has an acceptance unit 3031, a division unit 3033, an initial calculation unit 3035, a change unit 3039, an addition unit 3041, a modification unit 3043, a first calculation unit 3045 and an output unit 3047.

The acceptance unit 3031 receives initial data and various instructions. The division unit 3033 divides the initial data into blocks. The initial calculation unit 3035 executes initial processing. The initial processing will be described later. The change unit 3039 executes change processing. The change processing will be described later. The addition unit 3041 executes addition processing. The addition processing will be described later. The modification unit 3043 executes modification processing. The modification processing will be described later. The first calculation unit 3045 executes calculation processing. The calculation processing will be described later. The output unit 3047 outputs a second hash value.

The aforementioned acceptance unit 3031, division unit 3033, initial calculation unit 3035, change unit 3039, addition unit 3041, modification unit 3043, first calculation unit 3045 and output unit 3047 are realized using hardware resources (for example, refer to FIG. 43) and programs that cause a processor to execute the processing that will be described below.

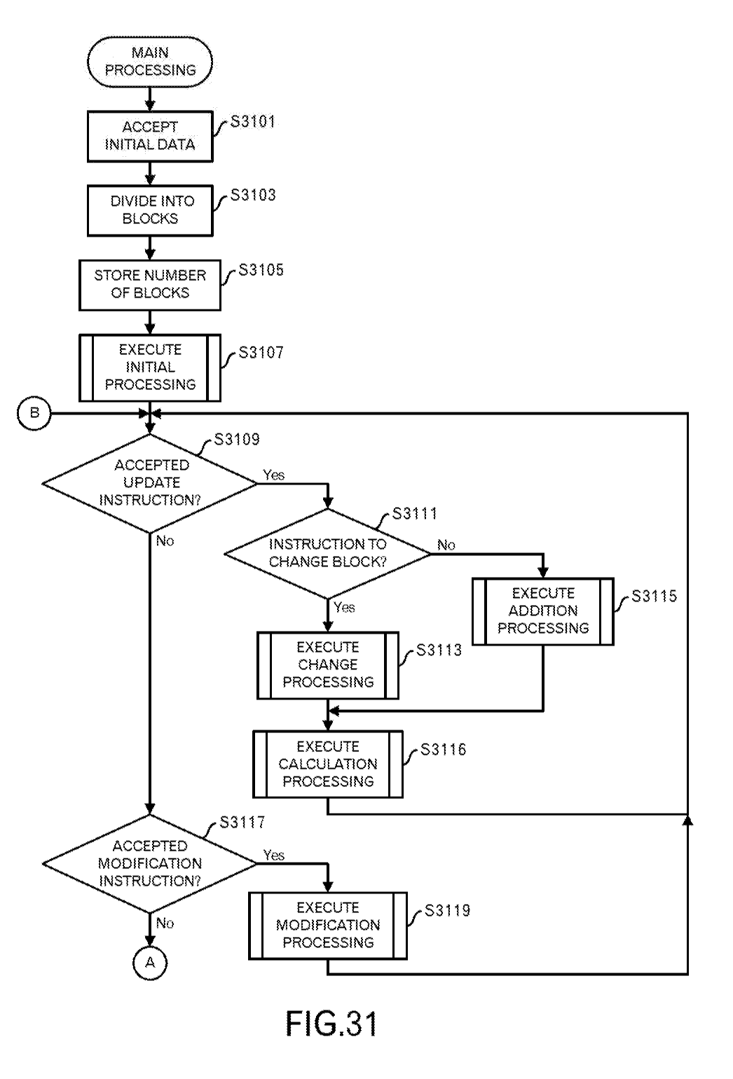

FIG. 31 illustrates a main processing flow. The acceptance unit 3031 accepts initial data (S3101). The initial data is an object for which a hash value is found, that is, the original data.

The division unit 3033 divides the initial data into blocks having a predetermined length (S3103). For example, the division unit 3033 divides the initial data into 64-kibibyte blocks. The divided blocks are stored in the block storage unit 3001. The division unit 3033 stores the number of blocks in the total number storage unit 3003 (S3105).

The initial calculation unit 3035 executes initial processing (S3107). In the initial processing, a second hash value is calculated based on the initial data.

FIG. 33 illustrates an example of the module construction of the initial calculation unit 3035. The initial calculation unit 3035 has a second calculation unit 3301, a first conversion unit 3303, a third calculation unit 3305 and a second conversion unit 3307.

The second calculation unit 3301 calculates first hash values based on each block. The first conversion unit 3303 converts the first hash values to first hash matrices. The third calculation unit 3305 calculates first products. The second conversion unit 3307 converts a second hash matrix to a second hash value.

The aforementioned second calculation unit 3301, first conversion unit 3303, third calculation unit 3305 and second conversion unit 3307 are realized using hardware resources (for example, refer to FIG. 43) and programs that cause a processor to execute the processing that will be described below.

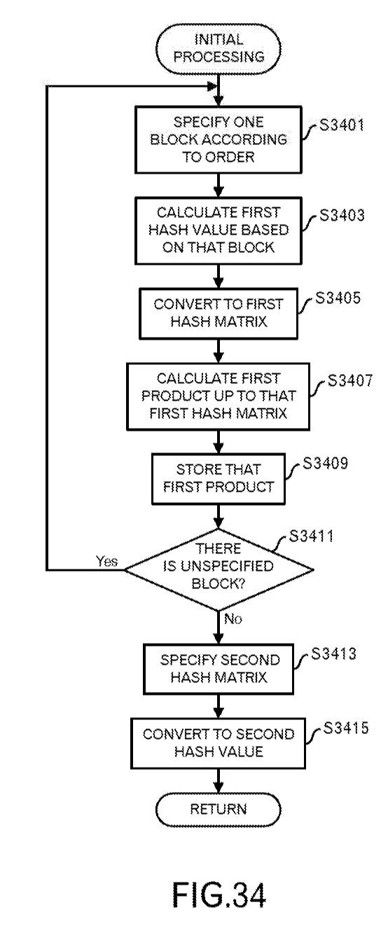

FIG. 34 illustrates a processing flow of the initial processing. The initial calculation unit 3035 specifies one block in order (S3401). First, the first block X₁ is specified. After that the next blocks are specified in order from X₂ to X_{N}. In the following, the block specified in S3401 is written as Xᵢ. Here, i represents a block number.

The second calculation unit 3301 calculates a first hash value Hᵢ based on the block Xᵢ (S3403). The method for calculating a hash value is based on a conventional technique.

The first conversion unit 3303 converts the first hash value Hᵢ to a first hash matrix Aᵢ (S3405). For example, the first hash value Hᵢ is divided into plural codes, and a first hash matrix Aᵢ is generated by assigning each of these codes to a predetermined element.

The third calculation unit 3305 calculates a first product Cᵢ up to that first hash matrix (S3407). More specifically, the first product Cᵢ is calculated by multiplying the first product Cᵢ₋₁ that corresponds to the block Xᵢ₋₁ before the block Xᵢ that was specified in S3401 by the first hash matrix Aᵢ. When the first block X₁ is specified, the first hash matrix A₁ becomes the first product C₁ as it is. The third calculation unit 3305 then stores that first product Cᵢ in the first product storage unit 3009 (S3409).

The initial calculation unit 3035 determines whether or not there is an unspecified block (S3411). More specifically, when all of the blocks up to the last block X_{N} have already been specified, then it is determined that there is not an unspecified block. When it is determined that there is an unspecified block, the processing returns to the processing illustrated in S3401, and the processing described above is repeated.

On the other hand, when it is determined that there is not an unspecified block, the second conversion unit 3307 specifies a second hash matrix B (S3413). More specifically, the first product C_{N} that corresponds to the last block is the second hash matrix B. The second hash matrix B is stored in the second hash matrix storage unit 3015.

The second conversion unit 3307 converts the second hash matrix B to a second hash value Hₜ (S3415). For example, the second hash value Hₜ is generated by combining values as codes, which are represented by the elements in the second hash matrix B. The second hash value Hₜ is stored in the second hash value storage unit 3017. After the initial processing is finished, the processing returns to the main processing of the calling source.

Here, the explanation will return to the explanation of FIG. 31. The acceptance unit 3031 determines whether or not an update instruction has been accepted (S3109). An update instruction may be an instruction resulting from user operation, or may be an instruction from another program. In this example, it is presumed that an instruction to change one block or to add one block is accepted.

When it is determined that an update instruction has been accepted, the acceptance unit 3031 determines whether or not the instruction is an instruction to change a block (S3111). When the instruction is determined to be an instruction to change a block, the change unit 3039 executes change processing (S3113). In the change processing, internal data is updated according to the block change.

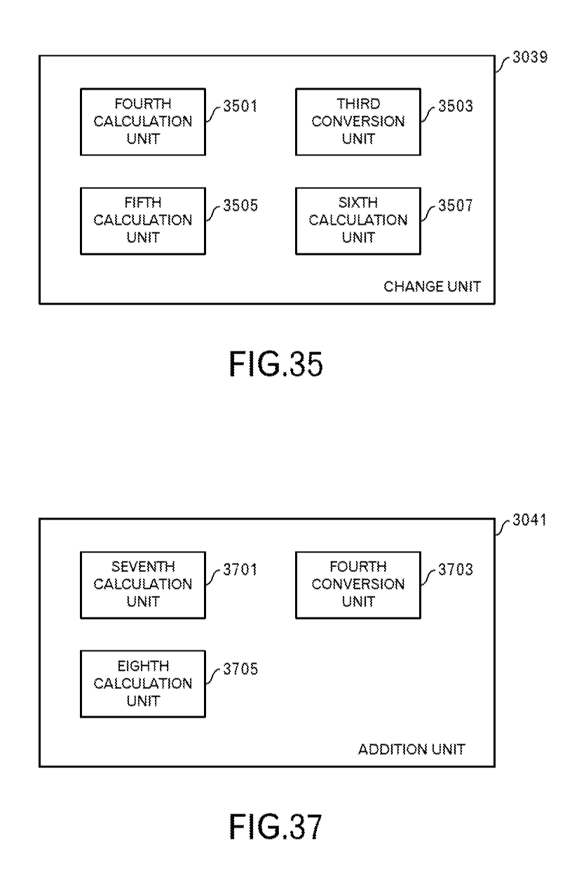

FIG. 35 illustrates an example of module construction of the change unit 3039. The change unit 3039 has a fourth calculation unit 3501, a third conversion unit 3503, a fifth calculation unit 3505 and a sixth calculation unit 3507.

The fourth calculation unit 3501 calculates a first hash value based on an updated block. The third conversion unit 3503 converts the first hash value to a first hash matrix. The fifth calculation unit 3505 calculates a second product. The sixth calculation unit 3507 calculates an inverse matrix of the first product.

The aforementioned fourth calculation unit 3501, third conversion unit 3503, fifth calculation unit 3505 and sixth calculation unit 3507 are realized by using hardware resources (for example, refer to FIG. 43) and programs for causing a processor to execute the processing described below.

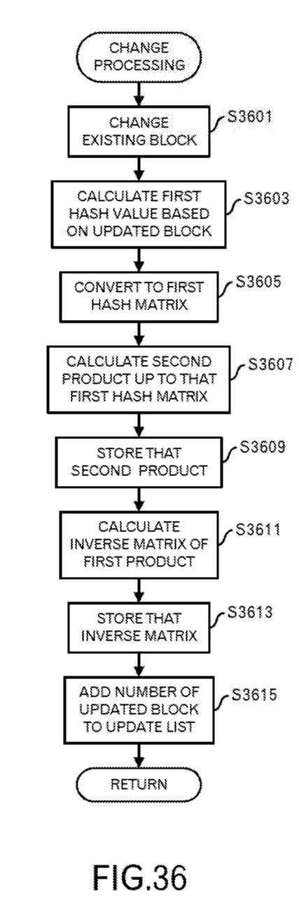

FIG. 36 illustrates a processing flow of the change processing. The change unit 3039 changes an existing block (S3601). Here, the original block before being changed is represented as X_{M}, and the updated block after being changed is represented as X*_{M}.

The fourth calculation unit 3501 calculates a first hash value H*_{M} based on the updated block X*_{M} (S3603). The method for calculating the hash value is based on a conventional technique.

The third conversion unit 3503 converts the first hash value H*_{M} to a first hash matrix A*_{M} (S3605). For example, the first hash matrix A*_{M} is generated by dividing the first hash value H*_{M} into plural codes and assigning each of those codes to a predetermined elements.

The fifth calculation unit 3505 calculates a second product C*_{M} up to the first hash matrix A*_{M} (S3607). The second product C*_{M} is found by multiplying the first product C_{M-1}, which was obtained by being lastly multiplied the hash matrix A_{M-1} that is based on the block X_{M-1} just before the updated block X*_{M}, by the first hash matrix A*_{M}. Then, the fifth calculation unit 3505 stores that second product C*_{M} in the second product storage unit 3011 (S3609).

The sixth calculation unit 3507 calculates an inverse matrix D_{M} of the first product C_{M} up to the original first hash matrix A_{M} that is based on the original block X_{M} (S3611). Then, the sixth calculation unit 3507 stores that inverse matrix D_{M} in the inverse matrix storage unit 3013 (S3613).

The change unit 3039 adds the number M of the updated block to the update list (S3615). After the change processing has ended, the processing returns to the main processing of the calling source.

Here, the explanation will return to the explanation of FIG. 31. When it is determined in S3111 that the instruction is not an instruction to change a block, or in other words, when the instruction is an instruction to add a block, the addition unit 3041 executes addition processing (S3115). In the addition processing, internal data is updated according to the addition of a block.

FIG. 37 illustrates an example of module configuration of the addition unit 3041. The addition unit 3041 has a seventh calculation unit 3701, a fourth conversion unit 3703 and an eighth calculation unit 3705.

The seventh calculation unit 3701 calculates a first hash value based on a newly added block. The fourth conversion unit 3703 converts the first hash value to a first hash matrix. The eighth calculation unit 3705 calculates a first product.

The aforementioned seventh calculation unit 3701, fourth conversion unit 3703 and eighth calculation unit 3705 are realized by hardware resources (for example, refer to FIG. 43), and programs that cause a processor to execute the processing described below.

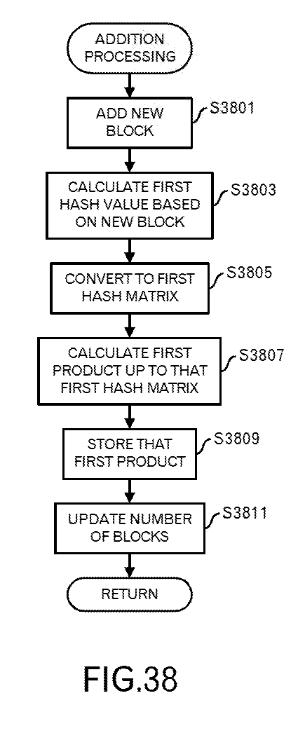

FIG. 38 illustrates a processing flow of the addition processing. The addition unit 3041 adds a new block X_{N+1} after the last block X_{N} (S3801).

The seventh calculation unit 3701 calculates a first hash value H_{N+1} based on the new block X_{N+1} (S3803). The method for calculating the hash value is based on a conventional technique.

The fourth conversion unit 3703 converts that first hash value H_{N+1} to a first hash matrix A_{N+1} (S3805).

The eighth calculation unit 3705 calculates a first product C_{N+1} up to the first hash matrix A_{N+1} (S3807). The first product C_{N+1} is found by multiplying the first product C_{N}, which was obtained by being lastly multiplied with the hash matrix A_{N} that is based on the last block X_{N}, by the first hash matrix A_{N+1}. Then the eighth calculation unit 3705 stores that first product C_{N+1} in the first product storage unit 3009 (S3809).

The addition unit 3041 updates the number of blocks (S3811). More specifically, 1 is added to the number of blocks. After the addition processing has ended, the processing returns to the main processing of the calling source.

Here, the explanation returns to the explanation of FIG. 31. After the change processing or addition processing has ended, the first calculation unit 3045 executes calculation processing (S3116).

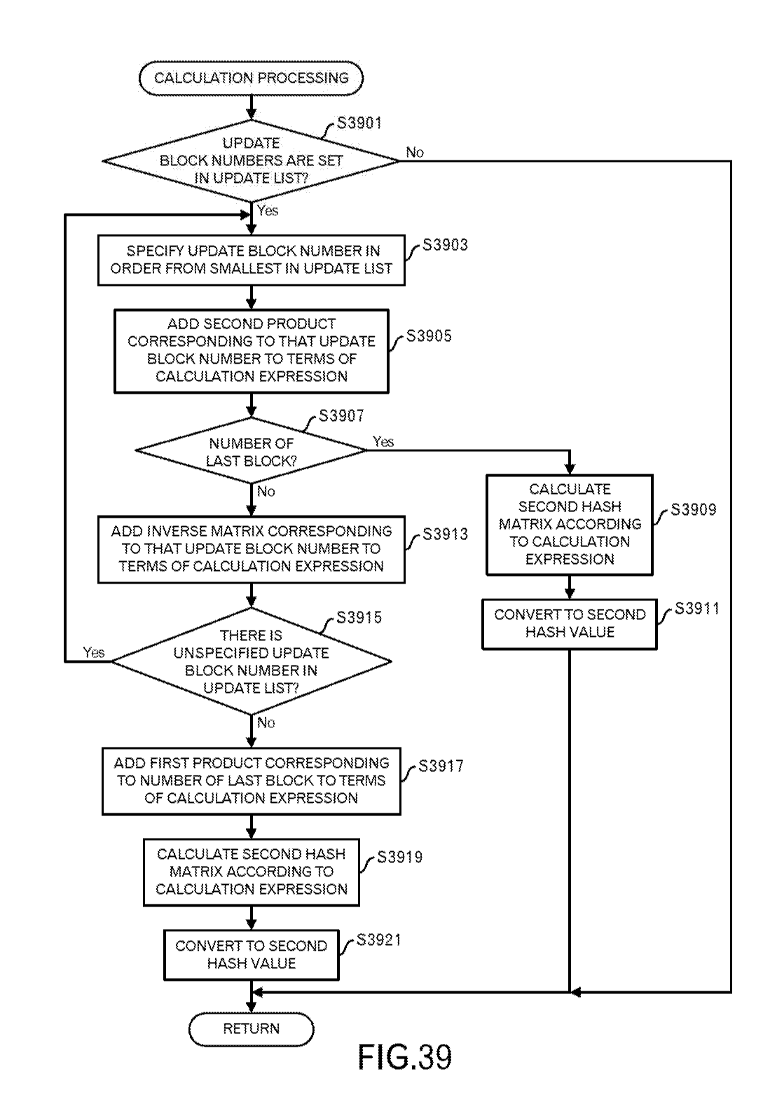

FIG. 39 illustrates a processing flow of the calculation processing. The first calculation unit 3045 determines whether or not numbers of updated blocks (hereinafter, referred to as update block numbers) are set in the update list (S3901). When it is determined that update block numbers are not set in the update list, the calculation processing ends, and the processing returns to the main processing of the calling source.

However, when it is determined that update block numbers are set in the update list, the first calculation unit 3045 specifies, in the update list, an update block number in order from the smallest (S3903). Here, the specified update block number is written as j.

The first calculation unit 3045 adds a second product C*ⱼ that corresponds to the update block number j to a term in the calculation expression (S3905). That term is then stored in the calculation expression storage unit 3021.

The first calculation unit 3045 determines whether or not the update block number j is the last block number N (S3907). When it is determined that the update block number j is the last block number N, the first calculation unit 3045 calculates a second hash matrix B according to the calculation expression (S3909). The second hash matrix B is stored in the second hash matrix storage unit 3015.

The first calculation unit 3045 converts the second hash matrix B to a second hash value Hₜ (S3911). For example, the second hash value Hₜ is generated by combining values as codes, which are represented by the elements of the second hash matrix B. The second hash value Hₜ is stored in the second hash value storage unit 3017. The calculation processing then ends, and the processing returns to the main processing of the calling source.

In S3907, when it is determined that the update block number j that was specified in S3903 is not the number N of the last block, the first calculation unit 3045 adds the inverse matrix Dⱼ that corresponds to the update block number j to a term of the calculation expression (S3913).

The first calculation unit 3045 determines whether or not there is an unspecified update block numbers in the update list (S3915). When it is determined that there is an unspecified update block number in the update list, the processing returns to the processing of S3903, and the processing described above is repeated.

However, when it is determined that there are no unspecified update block numbers in the update list, the first calculation unit 3045 adds the first product C_{N} that corresponds to the number N of the last block to the terms of the calculation expression (S3917).

The first calculation unit 3045 calculates a second hash matrix B according to the calculation expression (S3919). The second hash matrix B is stored in the second hash matrix storage unit 3015.

The first calculation unit 3045 converts the second hash matrix B to a second hash value Hₜ (S3921). The second hash value Hₜ is stored in the second hash value storage unit 3017. After the calculation processing ends, the processing returns to the main processing of the calling source.

Here, the explanation will return to the explanation of FIG. 31. In S3109, when it is determined that an update instruction has not been accepted, the acceptance unit 3031 determines whether or not a modification instruction has been received (S3117). A modification instruction may be an instruction according to user operation, or may be an instruction from another program. When it is determined that a modification instruction has been accepted, the modification unit 3043 executes modification processing (S3119). In the modification processing, the first product of an updated block is modified.

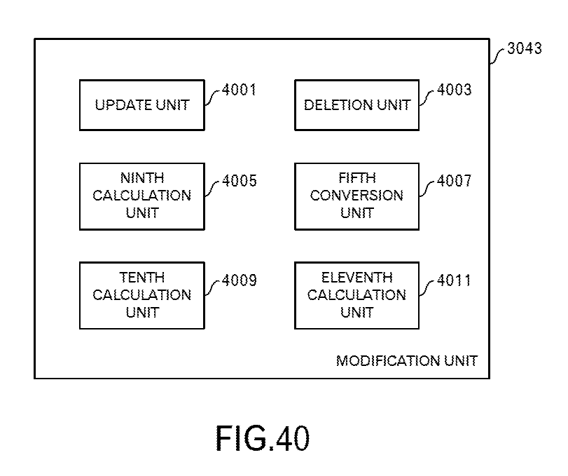

FIG. 40 illustrates an example of the module configuration of the modification unit 3043. The modification unit 3043 has an update unit 4001, a deletion unit 4003, a ninth calculation unit 4005, a fifth conversion unit 4007, a tenth calculation unit 4009 and an eleventh calculation unit 4011.

The update unit 4001 updates a first product. The deletion unit 4003 deletes update block numbers from the update list. The ninth calculation unit 4005 calculates a first hash value. The fifth conversion unit 4007 converts the first hash value to a first hash matrix. The tenth calculation unit 4009 calculates a second product. The eleventh calculation unit 4011 calculates an inverse matrix of the first product.

The aforementioned update unit 4001, deletion unit 4003, ninth calculation unit 4005, fifth conversion unit 4007, tenth calculation unit 4009 and eleventh calculation unit 4011 are realized by hardware resources (for example, refer to FIG. 43) and programs that cause a processor to execute the processing described below.

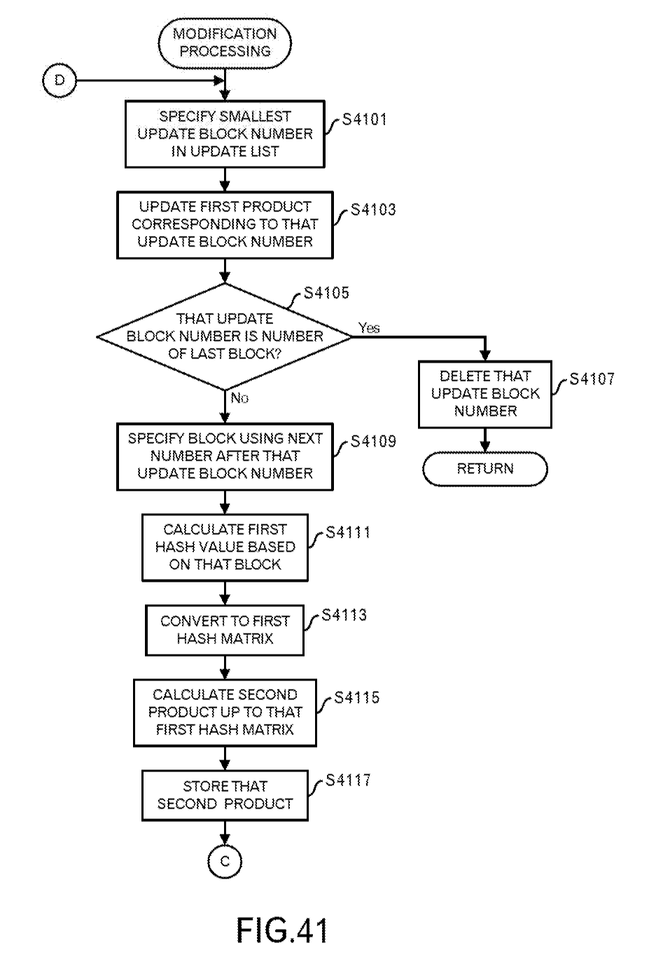

FIG. 41 illustrates a processing flow of the modification processing. The modification unit 3043 specifies the smallest update block number in the update list (S4101). Here, the specified update block number is represented as j.

The update unit 4001 updates the first product Cⱼ that corresponds to the update block number j (S4103). More specifically the second product C*ⱼ that corresponds to the update block number j is copied to the first product. Here, an updated first product is written as C_{[j]}.

The deletion unit 4003 determines whether or not the update block number j is the number N of the last block (S4105).

When it is determined that the update block number j is the number N of the last block, the deletion unit 4003 deletes that update block number j from the update list (S4107). Then, the modification processing ends and the processing returns to the main processing of the calling source.

However, when it is determined that the update block number j is not the number N of the last block, the ninth calculation unit 4005 specifies the block Xⱼ₊₁ (in the case that the block has been changed, the changed block X*ⱼ₊₁) using the next number j+1 subsequent to the update block number j (S4109).

The ninth calculation unit 4005 calculates a first hash value Hⱼ₊₁ (or first hash value H*ⱼ₊₁) based on the block Xⱼ₊₁ (or changed block X*ⱼ₊₁) that was specified in S4109 (S4111). The method for calculating the hash value is based on a conventional technique.

The fifth conversion unit 4007 converts the first hash value Hⱼ₊₁ (or first hash value H*ⱼ₊₁) to a first hash matrix Aⱼ₊₁ (or first hash matrix A*ⱼ₊₁) (S4113).

The tenth calculation unit 4009 calculates a second product C*ⱼ₊₁ (or second product C**ⱼ₊₁) up to the first hash matrix Aⱼ₊₁ (or first hash matrix A*ⱼ₊₁) (S4115). The second product C*ⱼ₊₁ (or second product C**ⱼ₊₁) is found by multiplying the first product C*ⱼ that corresponds to the update block number j that was specified in S4101 by the first hash matrix Aⱼ₊₁ (or first hash matrix A*ⱼ₊₁).

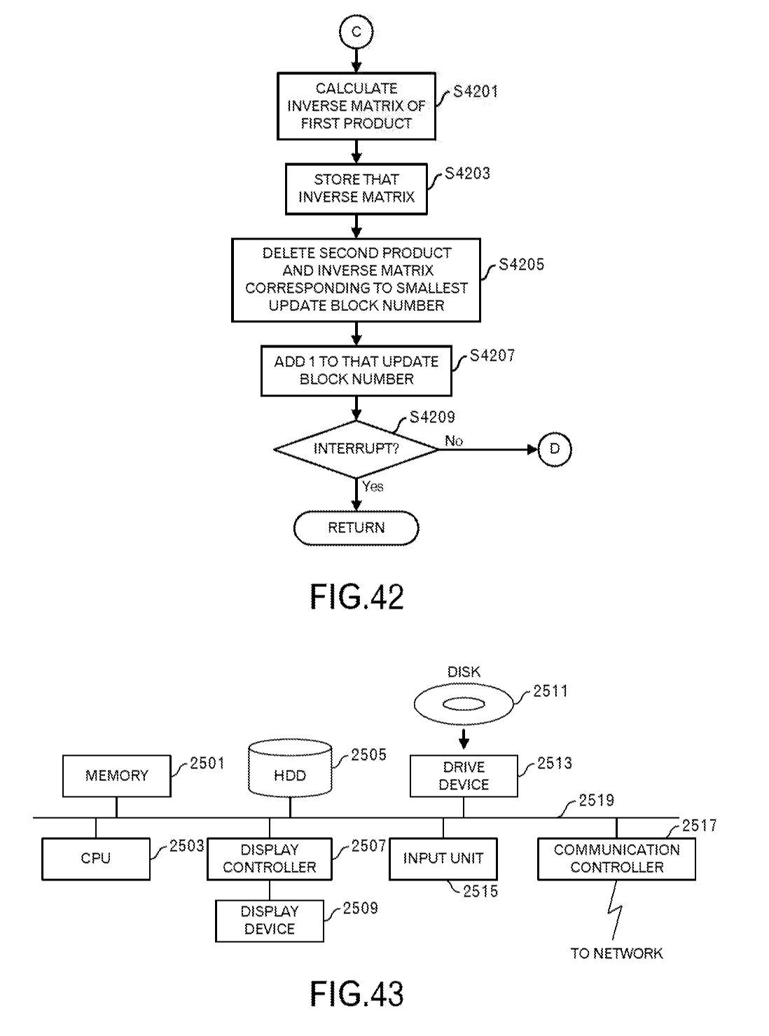

The tenth calculation unit 4009 stores the calculated second product C*ⱼ₊₁ (or second product C**ⱼ₊₁) in the second product storage unit 3011 (S4117). Then processing shifts to the processing of S4201 illustrated in FIG. 42 by way of terminal C.

The eleventh calculation unit 4011 calculates an inverse matrix Dⱼ₊₁ of the first product Cⱼ₊₁ up to the original first hash matrix Aⱼ₊₁ based on the original block Xⱼ₊₁ that corresponds to the next number j+1 of the smallest update block number j that was specified in S4101 (S4201). The eleventh calculation unit 4011 then stores that inverse matrix Dⱼ₊₁ in the inverse matrix storage unit 3013 (S4203).

The deletion unit 4003 deletes the second product and the inverse matrix Dⱼ that correspond to the smallest update block number j (S4205). The modification unit 3043 adds 1 to the update block number j in the update list (S4207). In other words, the smallest update block number j in the update list is changed into update block number j+1.

The modification unit 3043 determines whether or not to interrupt the modification processing (S4209). For example, the modification processing may be interrupted when the smallest update block number j reaches a predetermined number. The modification unit 3043 may also determine whether or not to interrupt the modification processing based on the processing load of the hash generation apparatus. It may also be possible to interrupt the modification processing when an interrupt instruction according to user operation is accepted. Moreover, it is also possible to interrupt the modification processing when an interrupt instruction is accepted from another program. When it is determined to interrupt the modification processing, the modification processing ends and the processing returns to the main processing of the calling source.

However, when it is determined not to interrupt the modification processing, the processing returns to the processing of S4101 illustrated in FIG. 41 by way of terminal D.

Here, the explanation will return to the explanation of FIG. 31. After the modification processing ends, the processing returns to the processing illustrated in S3109, and the processing described above is repeated.

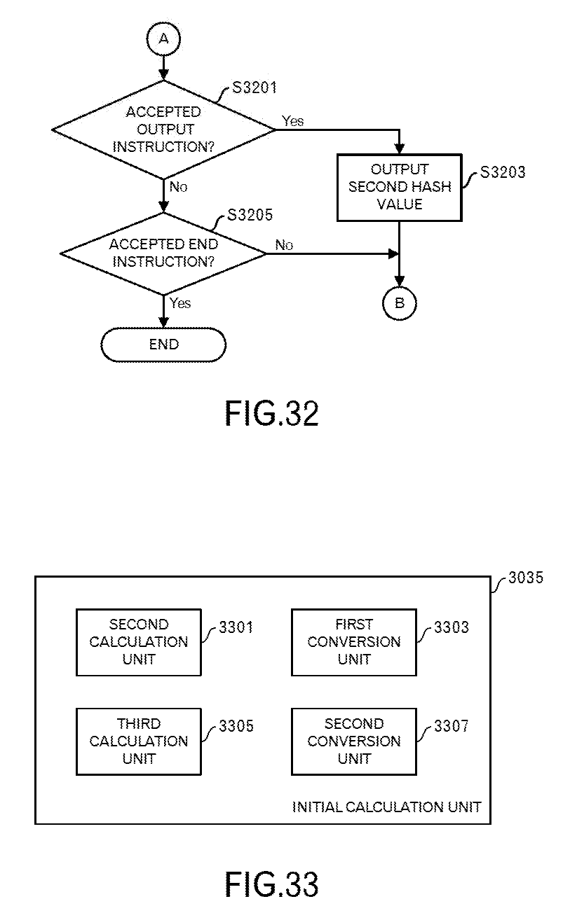

When it is determined in S3117 that a modification instruction was not accepted, the processing shifts to the processing of S3201 illustrated in FIG. 32 by way of terminal A. The acceptance unit 3031 determines whether or not an output instruction has been accepted (S3201). An output instruction may be an instruction that is according to user operation, or may be an instruction from a program.

When it is determined that an output instruction was accepted, the output unit 3047 outputs the second hash value Hₜ that is stored in the second hash value storage unit 3017 (S3203). Then, the processing returns to the processing of S3109 illustrated in FIG. 31 by way of terminal B.

However, when it is determined that an output instruction has not been accepted, the acceptance unit 3031 determines whether or not an end instruction has been received (S3205). An end instruction may be an instruction according to user operation, or may also be an instruction from a program. When it is determined that an end instruction has not been accepted, the processing returns to the processing of S3109 illustrated in FIG. 31 by way of terminal B. However, when it is determined that an end instruction has been accepted, the main processing ends.

It may also be possible to omit the calculation processing that is illustrated in S3116 in FIG. 31, and execute the calculation processing before S3203 in FIG. 32.

In the following, an additional explanation about calculation will be given. It may also be possible to convert the codes that were divided from the hash value Hᵢ to a predetermined remainder. For example, the divided code is divided by 65521 and a remainder is found. The number 65521 is the largest prime number that is less than or equal to 65535. In this way, it is possible to apply the value of the code to a predetermined bit width.

Division for finding an inverse matrix is defined as described below, for example. Here, the value ‘m’ is a prime number (for example, 65521). Let ‘a’ be an integer that is equal to or greater than 0 and less than m. Let ‘b’ be an integer that is equal to or greater than 1 and less than m. Under these conditions, of the integers ‘c’ that satisfy a=b*c, those which are greater than or equal to 0 and smaller than m are taken as quotients.

When all of the elements that are included in a matrix are 0, the inverse matrix of that matrix is not determined. Therefore, when finding the hash matrix Aᵢ, in a case when all of the elements that are included in the matrix obtained by converting the hash value Hᵢ are 0, it may also be possible to find the hash matrix Aᵢ by adding a predetermined matrix (for example, a unit matrix) to that matrix.

In this embodiment, the products of matrices are found as described above. When finding products of matrices, expressions in which order of terms are different are not always equivalent. Therefore, in the expressions for finding products described above, not only the terms themselves, but also order of the terms are significant. For example, when the order of a block Xᵢ is changed, the hash value Hₜ will be different.

In the example described above, an inverse matrix D is stored. In this way, an amount of calculation in the calculation processing is reduced. However, it is also possible not to store the inverse matrix D. In that case, the inverse matrix storage unit 3013 does not need to be provided. In the change processing, the processing of S3611 and S3613 depicted in FIG. 36 may be omitted. In the modification processing, it may also be possible to omit the processing of S4201 and S4203 illustrated in FIG. 42. Similarly, it may also be possible to omit the deletion processing for deleting the inverse matrix Dⱼ in S4205. Moreover, in the calculation processing, in S3913 illustrated in FIG. 39, it may also be possible to calculate the inverse matrix Dⱼ of the first product Cⱼ that corresponds to the update block number. In this way, the amount of data that is stored may be reduced.

According to the present embodiment, it is possible to further reduce an amount of computation required for recalculating the hash matrix and the hash value.

Moreover, even though plural portions in the original data have been changed, it is possible to further reduce an amount of computation that is required for recalculating the hash matrix and the hash value.

Furthermore, even in a case in which many portions in the original data have been changed, it may also be possible to further reduce an amount of calculation that is required for recalculating the hash matrix and the hash value. There is also a good aspect in that an amount of internal data that is stored is reduced.

Although the embodiment of this invention was explained above, this invention is not limited to those. For example, aforementioned functional block configuration does not always correspond to actual program module configuration.

Moreover, the aforementioned configuration of each storage area is a mere example, and may be changed. Furthermore, as for the processing flow, as long as the processing results do not change, the turns of the steps may be exchanged or the steps may be executed in parallel.

In addition, the aforementioned hash generation apparatus is a computer apparatus as illustrated in FIG. 43. That is, a memory 2501, a CPU 2503 (central processing unit), a HDD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 43. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In those embodiments of this invention, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer apparatus as stated above, the hardware such as the CPU 2503 and the memory 2501, the OS and the application programs systematically cooperate with each other, so that various functions as described above in details are realized.

The aforementioned embodiment is summarized as follows:

An information processing apparatus relating to this embodiment includes: a memory and a processor coupled to the memory. And the processor is configured to: (A) calculate a first hash matrix for identifying original data, which corresponds to a first product multiplied by a partial hash matrix that is based on a last block of plural blocks divided from the original data, from a second product for each of blocks other than the last block, the second product for each of blocks other than the last block being stored in the memory and being calculated by multiplying from a partial hash matrix that is based on a first block of the plural blocks up to a partial hash matrix that is based on the block; and (B) calculate a second hash matrix for identifying changed data, by multiplying a third product of a fourth product multiplied lastly by a partial hash matrix that is based on a block immediately before a changed block and a partial hash matrix that is based on the changed block by an inverse matrix of a fifth product multiplied lastly by a partial hash matrix that is based on an unchanged original block and a sixth product multiplied lastly by a partial hash matrix that is based on the last block, upon detecting that a part of the original data has been changed.

In this way, it becomes possible to reduce an amount of computation required for recalculating hash data.

The processor may be configured to calculate the second hash matrix by multiplying, for each of changed blocks and in order from a head of changed blocks, the third product by the inverse matrix of the fifth product and the sixth product, upon detecting that a number of the changed blocks is more than 1.

In this way, even when plural portions of the original data are changed, it becomes possible to further reduce the amount of computation required for recalculating the hash data.

Furthermore, the processor may further be configured to update the fifth product by the third product to increment a block number for specifying the changed block, and the processor may be configured to set a block specified by the block number as the changed block.

In this way, even when many parts of the original data are changed, it is possible to further reduce the amount of computation required for recalculating the hash data. There is also a good aspect in that an amount of internal data that is stored is reduced.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
calculate a first hash matrix for identifying original data, which corresponds to a first product multiplied by a partial hash matrix that is based on a last block of a plurality of blocks divided from the original data, from a second product for each of blocks other than the last block, wherein the second product for each of blocks other than the last block is stored in the memory and has been calculated by multiplying from a partial hash matrix that is based on a first block of the plurality of blocks up to a partial hash matrix that is based on the block; and
calculate a second hash matrix for identifying changed data, by multiplying a third product of a fourth product multiplied lastly by a partial hash matrix that is based on a block immediately before a changed block and a partial hash matrix that is based on the changed block by an inverse matrix of a fifth product multiplied lastly by a partial hash matrix that is based on an unchanged original block and a sixth product multiplied lastly by a partial hash matrix that is based on the last block, upon detecting that a part of the original data has been changed.

2. The information processing apparatus as set forth in claim′, wherein the processor configured to:
calculate the second hash matrix by multiplying, for each of changed blocks and in order from a head of changed blocks, the third product by the inverse matrix of the fifth product and the sixth product, upon detecting that a number of the changed blocks is more than 1.

3. The information processing apparatus as set forth in claim′, wherein the processor is further configured to update the fifth product by the third product to increment a block number for specifying the changed block, and the processor is configured to set a block specified by the block number as the changed block.

4. The information processing apparatus as set forth in claim′, wherein the processor is further configured to output a hash value based on the second hash matrix.

5. A hash generation method, comprising:
calculating, by using a computer, a first hash matrix for identifying original data, which corresponds to a first product multiplied by a partial hash matrix that is based on a last block of a plurality of blocks divided from the original data, from a second product for each of blocks other than the last block, wherein the second product for each of blocks other than the last block is stored in the memory and has been calculated by multiplying from a partial hash matrix that is based on a first block of the plurality of blocks up to a partial hash matrix that is based on the block; and
calculating, by using the computer, a second hash matrix for identifying changed data, by multiplying a third product of a fourth product multiplied lastly by a partial hash matrix that is based on a block immediately before a changed block and a partial hash matrix that is based on the changed block by an inverse matrix of a fifth product multiplied lastly by a partial hash matrix that is based on an unchanged original block and a sixth product multiplied lastly by a partial hash matrix that is based on the last block, upon detecting that a part of the original data has been changed.

6. Anon-transitory computer-readable storage medium storing a program that causes a computer to execute a process, the process comprising:
calculating a first hash matrix for identifying original data, which corresponds to a first product multiplied by a partial hash matrix that is based on a last block of a plurality of blocks divided from the original data, from a second product for each of blocks other than the last block, wherein the second product for each of blocks other than the last block is stored in the memory and has been calculated by multiplying from a partial hash matrix that is based on a first block of the plurality of blocks up to a partial hash matrix that is based on the block; and
calculating a second hash matrix for identifying changed data, by multiplying a third product of a fourth product multiplied lastly by a partial hash matrix that is based on a block immediately before a changed block and a partial hash matrix that is based on the changed block by an inverse matrix of a fifth product multiplied lastly by a partial hash matrix that is based on an unchanged original block and a sixth product multiplied lastly by a partial hash matrix that is based on the last block, upon detecting that a part of the original data has been changed.
